(19) United States
(12) Patent Application Publication
(10) Pub. No.: US 2023/0288867 A1
(43) Pub. Date: Sep. 14, 2023

(54) PROCESS CARTRIDGE AND ELECTROPHOTOGRAPHIC APPARATUS

(71) Applicant: CANON KABUSHIKI KAISHA, Tokyo (JP)

(72) Inventors: HIDEHARU SHIMOZAWA, Tokyo (JP); KANAME WATARIGUCHI, Kanagawa (JP); CHIHARU NAKAZONO, Shizuoka (JP); TSUTOMU NISHIDA, Shizuoka (JP); ATSUSHI OKUDA, Kanagawa (JP); TAIJI KATSURA, Shizuoka (JP); YUICHI KIKUCHI, Shizuoka (JP)

(21) Appl. No.: 18/174,978

(22) Filed: Feb. 27, 2023

(30) Foreign Application Priority Data
Mar. 14, 2022 (JP) 2022-039619

(51) Int. Cl. G03G 21/18; G03G 5/147; G03G 9/097

(52) U.S. Cl. CPC G03G 21/1814; G03G 5/14769; G03G 9/09708

(57) ABSTRACT

A process cartridge detachably attachable to a main body of an electrophotographic apparatus, the process cartridge including an electrophotographic photosensitive member, a toner, and a developing member that feeds the toner to the electrophotographic photosensitive member, wherein the electrophotographic photosensitive member includes a surface layer containing a (meth)acrylic resin having a urethane structure, the toner includes a toner particle and a hydrotalcite particle as an external additive, and the hydrotalcite particle contains fluorine in filter fitting analysis in STEM-EDS analysis.

### BACKGROUND OF THE INVENTION

### Field of the Invention

The present disclosure relates to a process cartridge including an electrophotographic photosensitive member and an electrophotographic apparatus.

### Description of the Related Art

In recent electrophotographic apparatuses, an increase in life and an increase in speed are enhanced while a reduction in size and a reduction in cost are demanded. Unfortunately, an increase in life and an increase in speed are likely to cause a variety of problems in the electrophotographic process. Thus, addition of members and control units to solve those problems results in an increase in size of electrophotographic apparatuses and in cost. Accordingly, a variety of devices have been made for those various problems to provide compatibility between increases in life and speed and reductions in size and cost.

Those problems above include a problem of transfer properties that a toner is left on the electrophotographic photosensitive member (hereinafter, also referred to as “photosensitive member”) when a toner image formed on the electrophotographic photosensitive member is transferred onto a transfer material in the transferring step. If the transfer properties are poor, a large amount of transfer residual toner is left on the electrophotographic photosensitive member after the transferring step, obstructing a reduction in size of the waste toner container which recovers the transfer residual toner. This leads to a demand for a process cartridge having improved transfer properties.

Japanese Patent Application Laid-Open No. 2017-125892 discloses a toner including a polyester resin, a fluorine compound on the surface, and a layered inorganic mineral having interlayers modified with organic ions. By performing a surface treatment on the layered inorganic mineral, which is often present on the surface of the toner, with the fluorine compound, the fluorine compound having high polarity can be present on the toner surface efficiently, and can be tightly fixed to the toner surface. Thus, high charging properties and high charging stability can be provided. By providing appropriate hydrophobicity through modification of the interlayers of the layered inorganic mineral with organic ions, a large amount of layered inorganic mineral is present near surface of the toner particle during toner granulation in an aqueous medium, deformation of the toner and the charge control function thereof are demonstrated even with a significantly small amount of the layered inorganic mineral added. This can improve the low-temperature fixing properties, which can be a problem when a large amount of the layered inorganic mineral is added.

Japanese Patent Application Laid-Open No. 2008-64807 discloses a toner including an amorphous polyester resin, an addition polymerized resin, and a wax, the three components having solubility parameters satisfying a certain relational expression. By designing the toner such that the solubility parameters satisfy the certain relational expression, the amorphous polyester resin and the addition-polymerized resin can form a sea-island phase separation structure in which the wax is encompassed in the island addition-polymerized resin. This reduces the amount of the wax exposed from the toner surface, thereby providing effects of improving transfer properties and durability.

The specification according to U.S. Patent Application Publication No. 2017/184987 discloses an electrophotographic photosensitive member including a surface layer formed by curing a urethane acrylate having 6 or more radical polymerizable functional groups and a charge transport material having 4 radical polymerizable functional groups compounded in a ratio in a certain range. By controlling the content of the urethane acrylate having 6 or more radical polymerizable functional groups and that of the charge transport material having 4 radical polymerizable functional groups, cross-linking density of the cross-linked film can be enhanced while electrical properties required for the electrophotographic photosensitive member are satisfied. Thus, favorable resistance to wear can be demonstrated without imparting the electrical properties.

In the examinations of all the techniques by the present inventors, which are disclosed in Japanese Patent Application Laid-Open Nos. 2017-125892 and 2008-64807 and U.S. Patent Application Publication No. 2017/184987, the toners and the photosensitive member are insufficiently designed, resulting in insufficient transfer properties in repeated use under environments at high temperature and high humidity in some cases. Thus, the problems remain unsolved yet by these techniques.

Accordingly, an object of the present disclosure is to provide a process cartridge having improved transfer properties in repeated use under an environment at a high temperature and a high humidity.

### SUMMARY OF THE INVENTION

The above object is achieved by the present disclosure below. Specifically, the process cartridge according to the present disclosure is a process cartridge detachably attachable to a main body of an electrophotographic apparatus, the process cartridge including an electrophotographic photosensitive member, a toner, and a developing member that feeds the toner to the electrophotographic photosensitive member, wherein the electrophotographic photosensitive member includes a surface layer containing a (meth)acrylic resin having a urethane structure, the toner includes a toner particle and a hydrotalcite particle as an external additive, and the hydrotalcite particle contains fluorine in filter fitting analysis in STEM-EDS analysis.

Further features of the present disclosure will become apparent from the following description of exemplary embodiments with reference to the attached drawings.

### BRIEF DESCRIPTION OF THE DRAWINGS

FIG. 1 is a schematic view illustrating one example of an electrophotographic apparatus including a process cartridge including an electrophotographic photosensitive member, a toner, and a developing member.

FIG. 2A is a schematic view illustrating line analysis in STEM-EDS analysis.

FIG. 2B shows one example of X-ray intensities of fluorine and aluminum obtained in line analysis.

FIG. 2C shows another example of X-ray intensities of fluorine and aluminum obtained in line analysis.

### DESCRIPTION OF THE EMBODIMENTS

Preferred embodiments of the present disclosure will now be described in detail in accordance with the accompanying drawings.

Hereinafter, the present disclosure will be described in detail by way of suitable embodiments.

The present disclosure relates to a process cartridge detachably attachable to a main body of an electrophotographic apparatus, the process cartridge including: an electrophotographic photosensitive member, a toner, and a developing member that feeds the toner to the electrophotographic photosensitive member, wherein the electrophotographic photosensitive member includes a surface layer containing a (meth)acrylic resin having a urethane structure, the toner includes a toner particle and a hydrotalcite particle as an external additive, and the hydrotalcite particle contains fluorine in filter fitting analysis in STEM-EDS analysis.

The present disclosure further relates to an electrophotographic apparatus including the process cartridge.

The present inventors, who have conducted examination, have found that the toner and the photosensitive member in the related art are insufficiently designed, which may lead to insufficient transfer properties in repeated use under high temperature and high humidity environments in some cases.

Thus, the present inventors have found that the above problem can be solved by optimizing design of a combination of the photosensitive member and the toner, that is, the photosensitive member including a surface layer containing a (meth)acrylic resin having a urethane structure, the toner including a toner particle and a hydrotalcite particle as an external additive, and the hydrotalcite particle containing fluorine in filter fitting analysis in STEM-EDS analysis.

The present inventors consider the following mechanism which can solve the above problem with such a configuration.

The hydrotalcite particle contained as an external additive in the toner has strong positive charging properties. Thus, the hydrotalcite particle is positively charged on a developing member, i.e., a developing roller which feeds the toner to the photosensitive member, while a toner particle is negatively charged. As a result, electrostatic attraction acts between the hydrotalcite particle and the toner particle.

When the toner receives friction in a contact portion between the photosensitive member and the developing member, the positive charge of the fluorine-containing hydrotalcite particle becomes weaker than the strong positive charging properties of the hydrotalcite particle because fluorine contained in the hydrotalcite particle is located in a region closer to the negative side of the triboelectric series compared to the (meth)acrylic resin on the surface of the photosensitive member layer. Thus, the electrostatic attraction acting between the hydrotalcite particle and the toner particle is weakened, and the hydrotalcite particle migrates onto the surface of the photosensitive member. At this time, the elasticity of a resin having a urethane structure contained in the surface layer of the photosensitive member is enhanced, and the positive charge of the hydrotalcite particle is further weakened by increasing the friction applied to the toner in the contact portion between the photosensitive member and the developing roller. Thereby, a sufficient amount of the hydrotalcite particles can migrate onto the surface of the photosensitive member. Moreover, fluorine contained in the hydrotalcite particle as a layered compound causes slip of the hydrotalcite particle in the interlayer and can further increase friction when the toner receives friction in the contact portion between the photosensitive member and the developing roller.

After the photosensitive member is repeatedly used under an environment at a high temperature and a high humidity, hydrophilic discharge products are accumulated on the surface of the photosensitive member, and are solution cross-linked between the discharge products on the surface of the photosensitive member and the toner due to moisture in the environment. The present inventors infer that this increases the adhesive force between the surface of the photosensitive member and the toner, deteriorating transfer properties to transfer materials. However, the hydrotalcite particle, which migrates from the toner onto the surface of the photosensitive member, takes an anionic discharge product such as NOx into the interlayer through ion exchange, thereby reducing solution cross-linking caused between the discharge products on the surface of the photosensitive member and the toner, and reducing the adhesive force between the surface of the photosensitive member and the toner. As a result, favorable transfer properties to transfer materials are obtained.

Alternatively, by containing the hydrotalcite particle in the toner but not in the photosensitive member, the hydrotalcite particle can be continuously fed to the surface of the photosensitive member, and the above effects can be maintained even in repeated use.

The effect of the present disclosure, i.e., an improvement in transfer properties in repeated use under an environment at a high temperature and a high humidity can be achieved by the mechanism as described above in which the photosensitive member and the toner synergistically exert effects on each other.

### [Electrophotographic Photosensitive Member]

The electrophotographic photosensitive member according to the present disclosure includes a surface layer.

Examples of a method of producing the electrophotographic photosensitive member according to the present disclosure include a method of preparing coating solutions for layers described later, sequentially applying the coating solutions of the desired layers, and drying the coatings. At this time, examples of the method of applying the coating solution include immersion coating, spray coating, inkjet coating, roll coating, die coating, blade coating, curtain coating, wire bar coating, and ring coating. Among these, preferred is immersion coating from the viewpoint of efficiency and productivity.

Hereinafter, a support and layers will be described.

### <Support>

In the present disclosure, the electrophotographic photosensitive member includes a support. In the present disclosure, the support is preferably an electroconductive support having conductivity. Examples of the shape of the support include cylindrical, belt-like, and sheet-like shapes. Among these, preferred is a cylindrical support. The support may have a surface subjected to an electrochemical treatment such as anode oxidation, blasting, or machining.

Preferred materials for the support are metals, resins, and glass.

Examples of the metals include aluminum, iron, nickel, copper, gold, stainless steel, and alloys thereof. Among these, aluminum is preferred. In short, a preferred example of the support is an aluminum support.

The resins and glass may have conductivity given by mixing or coating an electroconductive material.

### <Electroconductive Layer>

In the electrophotographic photosensitive member according to the present disclosure, an electroconductive layer may be disposed on the support. When the electroconductive layer is disposed, scars or concave portions and convex portions on the support surface can be covered, and reflection of light from the support surface can be controlled.

The electroconductive layer preferably contains an electroconductive particle and a resin.

Examples of materials for the electroconductive particle include metal oxides, metals, and carbon black.

Examples of the metal oxides include zinc oxide, aluminum oxide, indium oxide, silicon oxide, zirconium oxide, tin oxide, titanium oxide, magnesium oxide, antimony oxide, and bismuth oxide. Examples of the metals include aluminum, nickel, iron, nichrome, copper, zinc, and silver.

Among these, preferred is use of metal oxides as the electroconductive particle, and particularly more preferred is used of titanium oxide, tin oxide, or zinc oxide.

If a metal oxide is used as the electroconductive particle, the surface of the metal oxide may be treated with a silane coupling agent, or the metal oxide may be doped with an element such as phosphorus or aluminum or an oxide thereof. Examples of elements and oxides thereof for doping include phosphorus, aluminum, niobium, and tantalum.

The electroconductive particle may have a multilayered structure including a core material particle and a coating layer for coating the particle. Examples of the core material particle include titanium oxide, barium sulfate, and zinc oxide. Examples of the coating layer include metal oxides such as tin oxide and titanium oxide.

If a metal oxide is used as the electroconductive particle, the metal oxide has a volume average particle size of preferably 1 to 500 nm, more preferably 3 to 400 nm.

Examples of the resin include polyester resins, polycarbonate resins, polyvinyl acetal resins, acrylic resins, silicone resins, epoxy resins, melamine resins, polyurethane resins, phenol resins, and alkyd resins.

The electroconductive layer may further contain a shielding agent such as silicone oil, a resin particle, or titanium oxide.

The electroconductive layer has an average thickness of preferably 1 to 50 μm, particularly preferably 3 to 40 μm.

The electroconductive layer can be formed by preparing a coating solution for an electroconductive layer containing the above-mentioned materials and a solvent, forming a coating, and drying the coating. Examples of the solvent used for the coating solution include alcohol-based solvents, sulfoxide-based solvents, ketone-based solvents, ether-based solvents, ester-based solvents, and aromatic hydrocarbon-based solvents. Examples of a method of dispersing the electroconductive particle in the coating solution for an electroconductive layer include those using a paint shaker, a sand mill, a ball mill, or a liquid collision type high-speed dispersing machine.

### <Undercoat Layer>

In the electrophotographic photosensitive member according to the present disclosure, an undercoat layer may be disposed on the support or the electroconductive layer. The undercoat layer, when disposed, can enhance the adhesive function of the interlayer and impart a charge injection blocking function.

The undercoat layer preferably contains a resin. Alternatively, an undercoat layer may be formed with a cured film obtained by polymerizing a composition containing a monomer having a polymerizable functional group.

Examples of the resin include polyester resins, polycarbonate resins, polyvinyl acetal resins, acrylic resins, epoxy resins, melamine resins, polyurethane resins, phenol resins, polyvinylphenol resins, alkyd resins, polyvinyl alcohol resins, polyethylene oxide resins, polypropylene oxide resins, polyamide resins, polyamic acid resins, polyimide resins, polyamideimide resins, and cellulose resins.

Examples of the polymerizable functional group contained in the monomer having a polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic anhydride group, and a carbon-carbon double bond group.

In order to enhance electrical properties, the undercoat layer may further contain an electron transport substance, a metal oxide, a metal, an electroconductive polymer, and the like. Among these, preferred is use of an electron transport substance and a metal oxide.

Examples of the electron transport substance include quinone compounds, imide compounds, benzimidazole compounds, cyclopentadienylidene compounds, fluorenone compounds, xanthone compounds, benzophenone compounds, cyanovinyl compounds, halogenated aryl compounds, silole compounds, and boron-containing compounds. The undercoat layer may be formed as a cured film by using an electron transport substance having a polymerizable functional group as an electron transport substance and the monomer having a polymerizable functional group and copolymerizing these.

Examples of the metal oxide include indium tin oxide, tin oxide, indium oxide, titanium oxide, zinc oxide, aluminum oxide, and silicon dioxide. Examples of the metal include gold, silver, and aluminum.

The undercoat layer may further contain additives.

The undercoat layer has an average thickness of preferably 0.1 to 50 μm, more preferably 0.2 to 40 μm, particularly preferably 0.3 to 30 μm.

The undercoat layer can be formed by preparing a coating solution for an undercoat layer containing the above-mentioned materials and a solvent, forming a coating, and drying and/or curing the coating. Examples of the solvent used for the coating solution include alcohol-based solvents, ketone-based solvents, ether-based solvents, ester-based solvents, and aromatic hydrocarbon-based solvents.

### <Photosensitive Layer>

The photosensitive layer included in the electrophotographic photosensitive member according to the present disclosure is mainly classified into (1) a multilayered photosensitive layer and (2) a monolayered photosensitive layer. The (1) multilayered photosensitive layer includes a charge generating layer containing a charge generating material and a charge transport layer containing a charge transport material. The (2) monolayered photosensitive layer is a photosensitive layer containing a charge generating material and a charge transport material together.

### (1) Multilayered Photosensitive Layer

The multilayered photosensitive layer includes a charge generating layer and a charge transport layer.

### (1-1) Charge Generating Layer

The charge generating layer preferably contains a charge generating material and a resin.

Examples of the charge generating material include azo pigments, perylene pigments, polycyclic quinone pigments, indigo pigments, and phthalocyanine pigments. Among these, preferred are azo pigments and phthalocyanine pigments. Among these phthalocyanine pigments, preferred are oxytitanium phthalocyanine pigments, chlorogallium phthalocyanine pigments, and hydroxygallium phthalocyanine pigments. The content of the charge generating material in the charge generating layer is preferably 40 to 85% by mass, more preferably 60 to 80% by mass relative to the total mass of the charge generating layer.

Examples of the resin include polyester resins, polycarbonate resins, polyvinyl acetal resins, polyvinyl butyral resins, acrylic resins, silicone resins, epoxy resins, melamine resins, polyurethane resins, phenol resins, polyvinyl alcohol resins, cellulose resins, polystyrene resins, polyvinyl acetate resins, and polyvinyl chloride resins. Among these, polyvinyl butyral resins are more preferred.

The charge generating layer may further contain additives such as an antioxidant and an ultraviolet absorbing agent. Specifically, examples thereof include hindered phenol compounds, hindered amine compounds, sulfur compounds, phosphorus compounds, and benzophenone compounds.

The charge generating layer has an average thickness of preferably 0.1 to 1 μm, more preferably 0.15 to 0.4 μm.

The charge generating layer can be formed by preparing a coating solution for a charge generating layer containing the above-mentioned materials and a solvent, forming a coating, and drying the coating. Examples of the solvent used for the coating solution include alcohol-based solvents, sulfoxide-based solvents, ketone-based solvents, ether-based solvents, ester-based solvents, and aromatic hydrocarbon-based solvents.

(1-2) Charge Transport Layer

The charge transport layer preferably contains a charge transport material and a resin.

Examples of the charge transport material include polycyclic aromatic compounds, heterocyclic compounds, hydrazone compounds, styryl compounds, enamine compounds, benzidine compounds, triarylamine compounds, and resins having groups derived from these substances. Among these, preferred are triarylamine compounds and benzidine compounds.

The content of the charge transport material in the charge transport layer is preferably 25 to 70% by mass, more preferably 30 to 55% by mass relative to the total mass of the charge transport layer.

Examples of the resin include polyester resins, polycarbonate resins, (meth)acrylic resins, and polystyrene resins. Among these, preferred are polycarbonate resins, polyester resins, and (meth)acrylic resins. Preferred polyester resins are polyarylate resins in particular.

The content ratio (mass ratio) of the charge transport material to the resin is preferably 4:10 to 20:10, more preferably 5:10 to 12:10.

The charge transport layer may contain additives such as an antioxidant, an ultraviolet absorbing agent, a plasticizer, a leveling agent, a slip properties imparting agent, and a wear resistance improver. Specifically, examples thereof include hindered phenol compounds, hindered amine compounds, sulfur compounds, phosphorus compounds, benzophenone compounds, siloxane modified resins, silicone oil, fluorinated resin particles, polystyrene resin particles, polyethylene resin particles, silica particles, alumina particles, and boron nitride particles.

The charge transport layer has an average thickness of preferably 5 to 50 μm, more preferably 8 to 40 μm, particularly preferably 10 to 30 μm.

The charge transport layer can be formed by preparing a coating solution for a charge transport layer containing the above-mentioned materials and a solvent, forming a coating, and drying the coating. Examples of the solvent used for the coating solution include alcohol-based solvents, ketone-based solvents, ether-based solvents, ester-based solvents, and aromatic hydrocarbon-based solvents. Among these solvents, preferred are ether-based solvents or aromatic hydrocarbon-based solvents.

### (2) Monolayered Photosensitive Layer

The monolayered photosensitive layer can be formed by preparing a coating solution for a photosensitive layer containing a charge generating material, a charge transport material, a resin, and a solvent, forming a coating on a support, and drying the coating. Examples of the charge generating material, the charge transport material, and the resin are the same as those listed as the materials in “(1) Multilayered photosensitive layer” above.

### <Protective Layer>

In the electrophotographic photosensitive member according to the present disclosure, a protective layer may be disposed on the photosensitive layer. The protective layer, when deposited, can improve durability.

For the purpose of imparting durability to increase life, the protective layer may be, for example, a highly strong layer containing a resin, and does not always contain an electroconductive particle and/or a charge transport material to enhance the charge transportability. However, from the viewpoint of enhancing the basic electrical properties of the photosensitive member, preferably, an electroconductive particle and/or a charge transport material and a resin are contained to satisfy the durability and the basic electrical properties.

Examples of the electroconductive particle include a particle of metal oxide such as titanium oxide, zinc oxide, tin oxide, and indium oxide.

Examples of the charge transport material include polycyclic aromatic compounds, heterocyclic compounds, hydrazone compounds, styryl compounds, enamine compounds, benzidine compounds, triarylamine compounds, and resins having groups derived from these substances. Among these, preferred are triarylamine compounds and benzidine compounds.

Examples of the resin include polyester resins, acrylic resins, phenoxy resins, polycarbonate resins, polystyrene resins, phenol resins, melamine resins, and epoxy resins. Among these, preferred are polycarbonate resins, polyester resins, and acrylic resins.

Alternatively, the protective layer may be formed as a cured film by polymerizing a composition containing a monomer having a polymerizable functional group. Examples of the reaction at this time include thermal polymerization reaction, light polymerization reaction, and radiation polymerization reaction. Examples of the polymerizable functional group contained in the monomer having a polymerizable functional group include an acryloyl group and a methacryloyl group. As the monomer having a polymerizable functional group, a material having charge transportability may be used.

The protective layer may contain additives such as an antioxidant, an ultraviolet absorbing agent, a plasticizer, a leveling agent, a slip properties imparting agent, and a wear resistance improver. Specifically, examples thereof include hindered phenol compounds, hindered amine compounds, sulfur compounds, phosphorus compounds, benzophenone compounds, siloxane modified resins, silicone oil, fluorinated resin particles, polystyrene resin particles, polyethylene resin particles, silica particles, alumina particles, and boron nitride particles.

The protective layer has an average thickness of preferably 0.5 to 10 μm, more preferably 1 to 7 μm.

The protective layer can be formed by preparing a coating solution for a protective layer containing the above-mentioned materials and a solvent, forming a coating on the photosensitive layer, and drying and/or curing the coating. Examples of the solvent used for the coating solution include alcohol-based solvents, ketone-based solvents, ether-based solvents, sulfoxide-based solvents, ester-based solvents, and aromatic hydrocarbon-based solvents.

### <Surface Layer>

In the electrophotographic photosensitive member according to the present disclosure, the surface layer contains a (meth)acrylic resin having a urethane structure.

The urethane structure indicates a structure represented by —NHC(═O)O—.

The surface layer used here is a portion of the photosensitive member brought into contact with the toner and a variety of members during the electrophotographic process. Among the layers forming the photosensitive member, the protective layer, the charge transport layer, the monolayered photosensitive layer, and the charge generating layer can be the surface layer. From the viewpoint of compatibility between the durability and the basic electrical properties in the electrophotographic process, the surface layer is preferably the protective layer or the charge transport layer, more preferably the protective layer.

The surface layer preferably has an elastic deformation rate of 45% or more. If the surface layer has an elastic deformation rate of 45% or more, a predetermined or higher elasticity is imparted to the surface layer, the friction applied to the toner is increased in the contact portion between the photosensitive member and the developing roller, and migration of the hydrotalcite particle contained in the toner onto the surface of the photosensitive member is promoted.

The surface layer is preferably formed as a cured film by polymerizing a composition containing a monomer having a polymerizable functional group. Examples of the reaction at this time include thermal polymerization reaction, light polymerization reaction, and radiation polymerization reaction. Examples of the polymerizable functional group contained in the monomer having a polymerizable functional group include an acryloyl group and a methacryloyl group. As the monomer having a polymerizable functional group, a material having charge transportability may be used.

Examples of the monomer having a polymerizable functional group include those represented by Formulae (A-1) to (A-3) below.

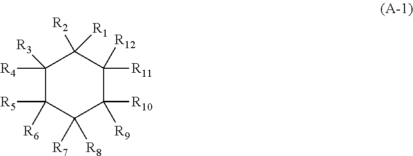

wherein at least 2 of R₁ to R₁₂ are a structure represented by Formula (U-1) below, and the remaining substituents are a hydrogen atom or a methyl group.

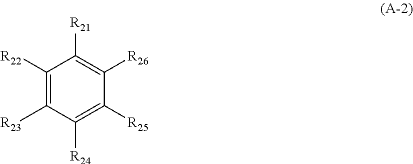

wherein at least 2 of R₂₁ to R₂₆ are a structure represented by Formula (U-1) below, and the remaining substituents are a hydrogen atom or a methyl group.

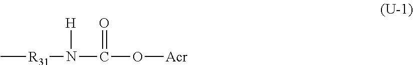

wherein R₃₁ is a single bond or a hydrocarbon group which may be substituted, and Acr represents an acryloyloxy or methacryloyloxy group which may be substituted.

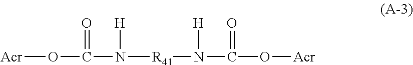

wherein Acr represents an acryloyloxy or methacryloyloxy group which may be substituted, and R₄₁ represents a hydrocarbon group which may be substituted.

Furthermore, specific examples of the monomer having a polymerizable functional group (hereinafter, also abbreviated to “OCL monomer”) include those represented by Formulae (B-1) to (B-17) below.

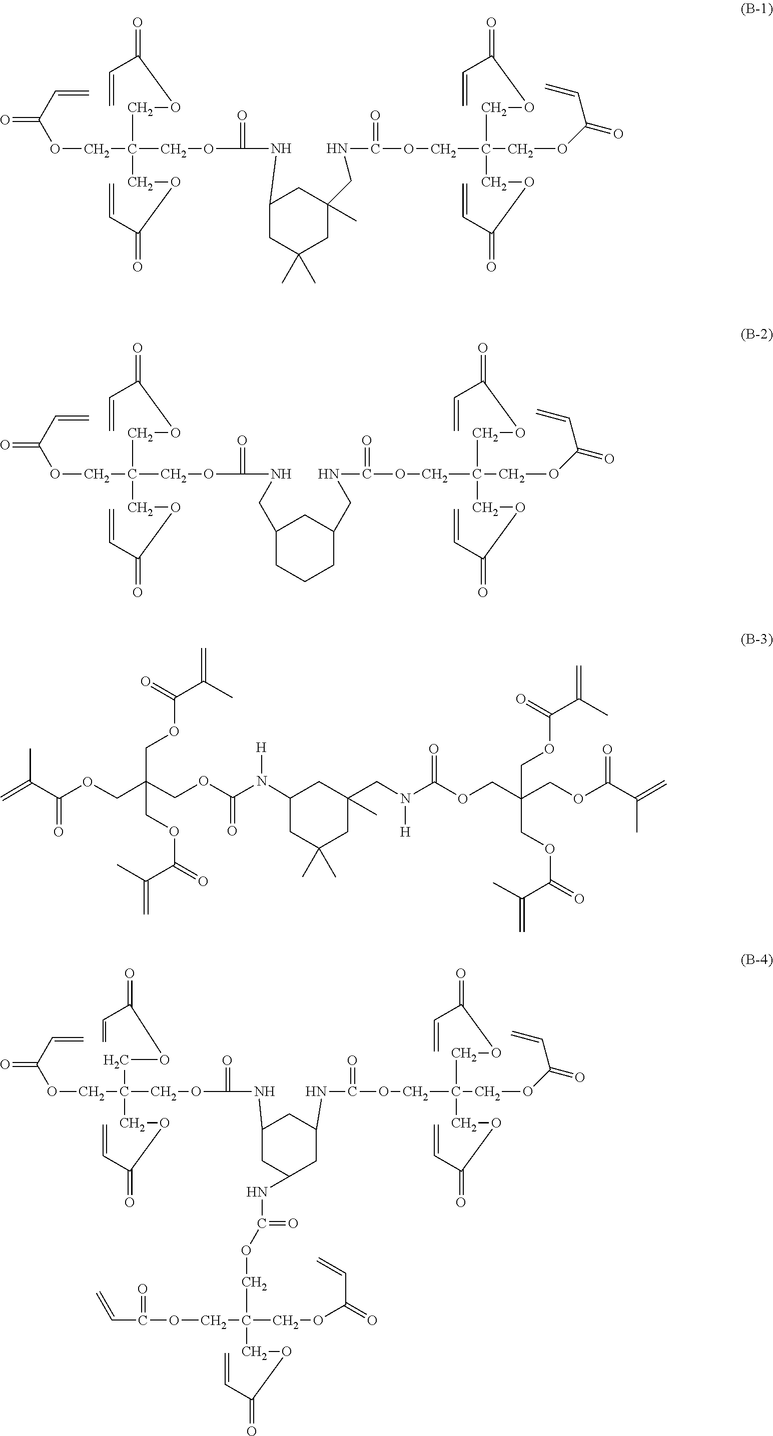 [SMILES: C=CC(=O)OCC(COC(=O)C=C)(COC(=O)C=C)COC(=O)NCC1(C)CC(NC(=O)OCC(COC(=O)C=C)(COC(=O)C=C)COC(=O)C=C)CC(C)(C)C1 ; C=CC(=O)OCC(COC(=O)C=C)(COC(=O)C=C)COC(=O)NCC1CCCC(CNC(=O)OCC(COC(=O)C=C)(COC(=O)C=C)COC(=O)C=C)C1 ; C=C(C)C(=O)OCC(COC(=O)NCC1(C)CC(NC(=O)OCC(COC(=O)C(=C)C)(COC(=O)C(=C)C)COC(=O)C(=C)C)CC(C)(C)C1)(COC(=O)C(=C)C)COC(=O)C(=C)C ; C=CC(=O)OCC(COC(=O)C=C)(COC(=O)C=C)COC(=O)NC1CC(NC(=O)OCC(COC(=O)C=C)(COC(=O)C=C)COC(=O)C=C)CC(NC(=O)OCC(COC(=O)C=C)(COC(=O)C=C)COC(=O)C=C)C1]

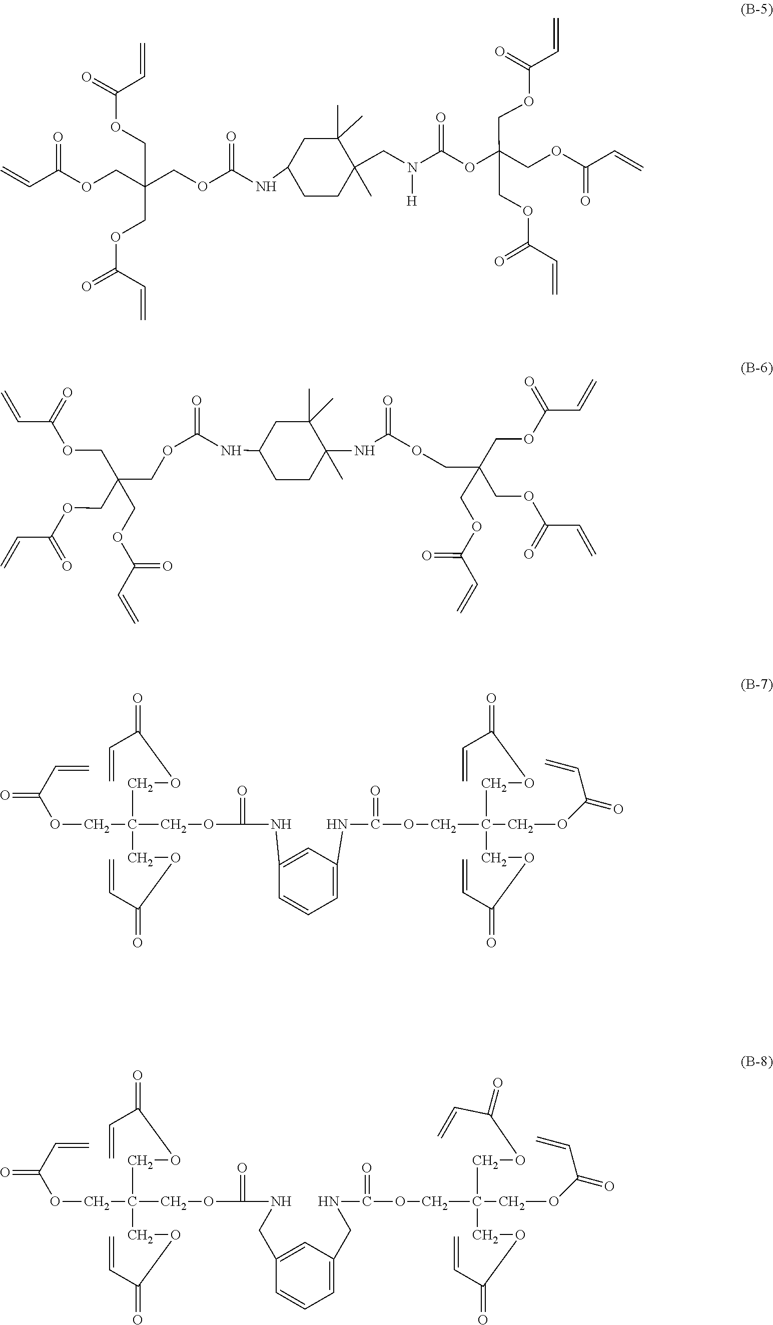

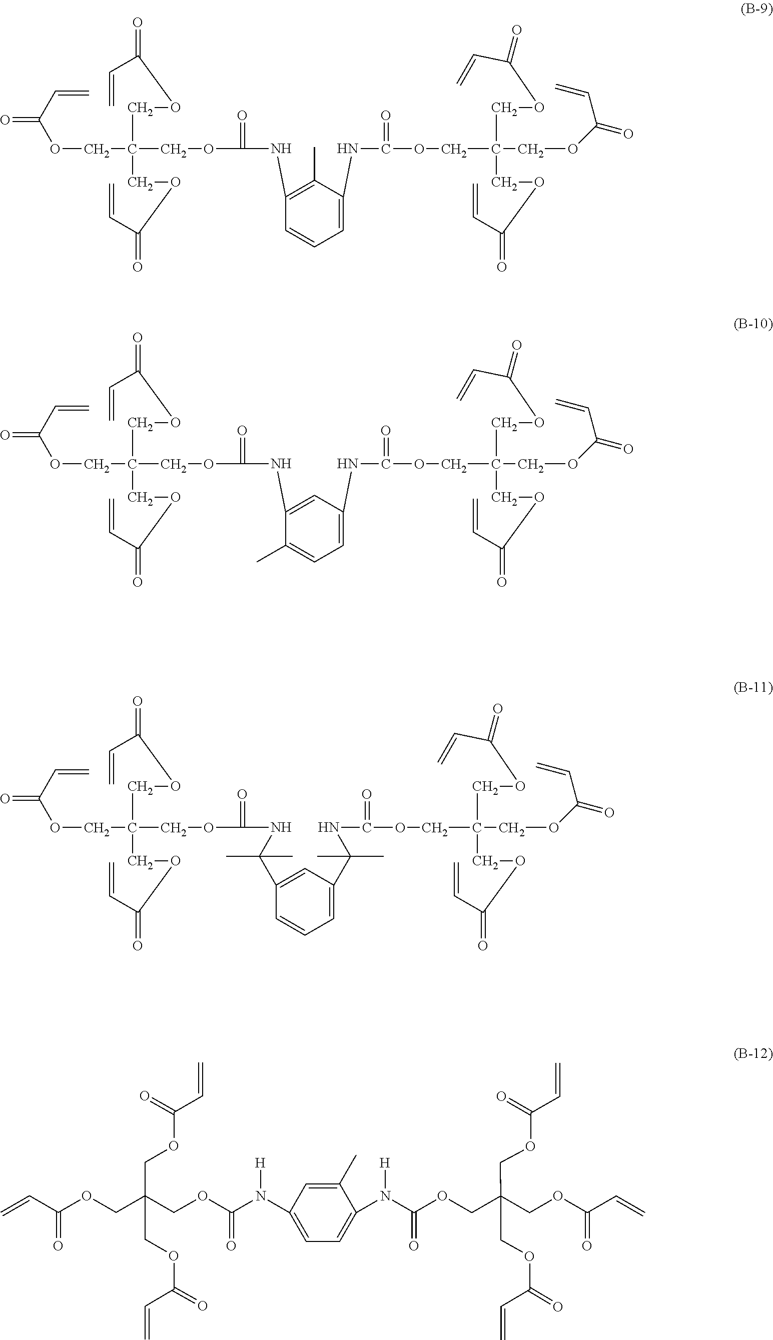 [SMILES: C=CC(=O)OCC(COC(=O)C=C)(COC(=O)C=C)COC(=O)Nc1cccc(NC(=O)OCC(COC(=O)C=C)(COC(=O)C=C)COC(=O)C=C)c1C ; C=CC(=O)OCC(COC(=O)C=C)(COC(=O)C=C)COC(=O)Nc1ccc(C)c(NC(=O)OCC(COC(=O)C=C)(COC(=O)C=C)COC(=O)C=C)c1 ; C=CC(=O)OCC(COC(=O)C=C)(COC(=O)C=C)COC(=O)NC(C)(C)c1cccc(C(C)(C)NC(=O)OCC(COC(=O)C=C)(COC(=O)C=C)COC(=O)C=C)c1 ; C=CC(=O)OCC(COC(=O)C=C)(COC(=O)C=C)COC(=O)Nc1ccc(NC(=O)OCC(COC(=O)C=C)(COC(=O)C=C)COC(=O)C=C)c(C)c1]

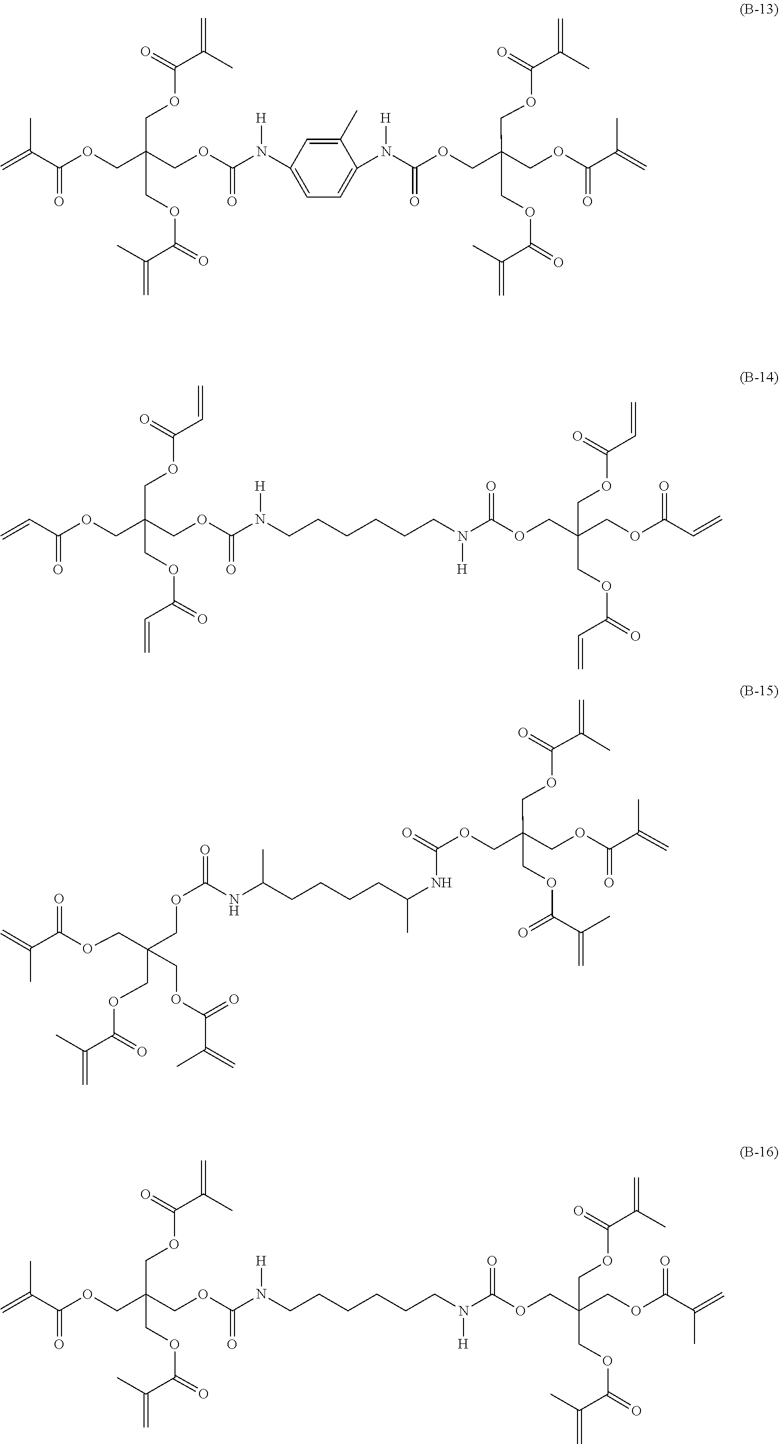

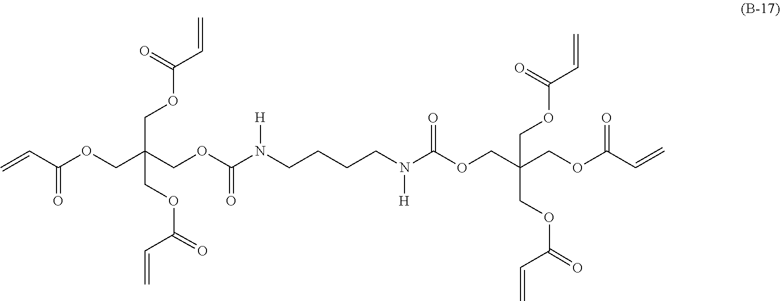 [SMILES: C=CC(=O)OCC(COC(=O)C=C)(COC(=O)C=C)COC(=O)NCCCCNC(=O)OCC(COC(=O)C=C)(COC(=O)C=C)COC(=O)C=C]

Examples of the monomer having a polymerizable functional group and having charge transportability include those represented by Formula (C-1) below.

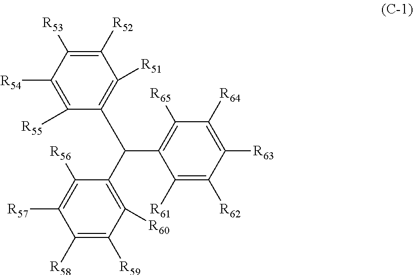

wherein R₅₁ to R₆₅ are a (meth)acryloyloxy group which may be substituted, a hydrogen atom, or a methyl group.

Specific examples of the monomer having a polymerizable functional group and having a charge transportability includes those represented by Formulae (D-1) to (D-12) below.

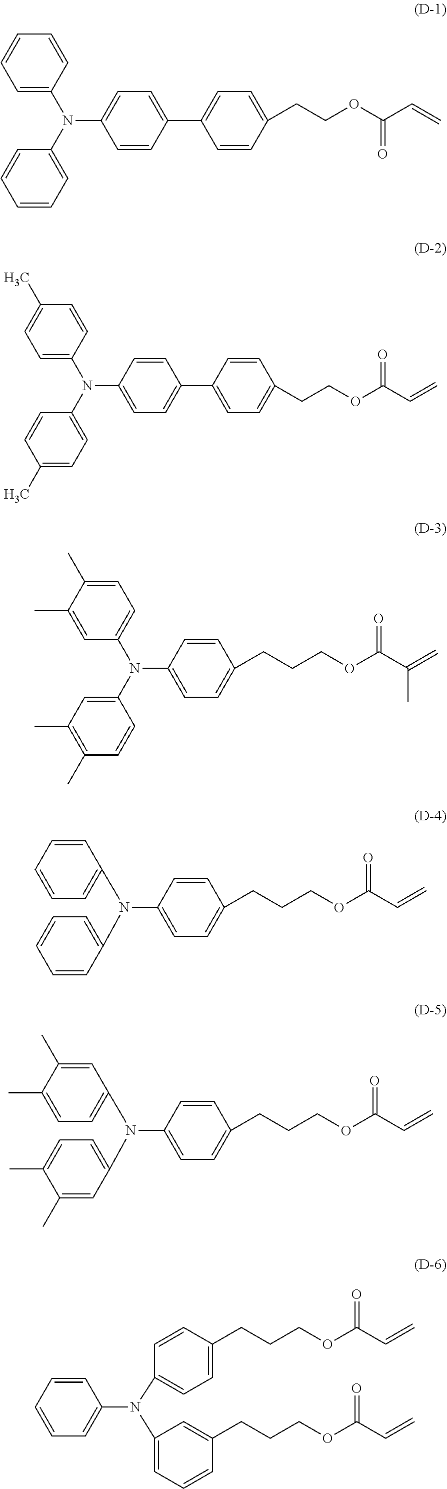

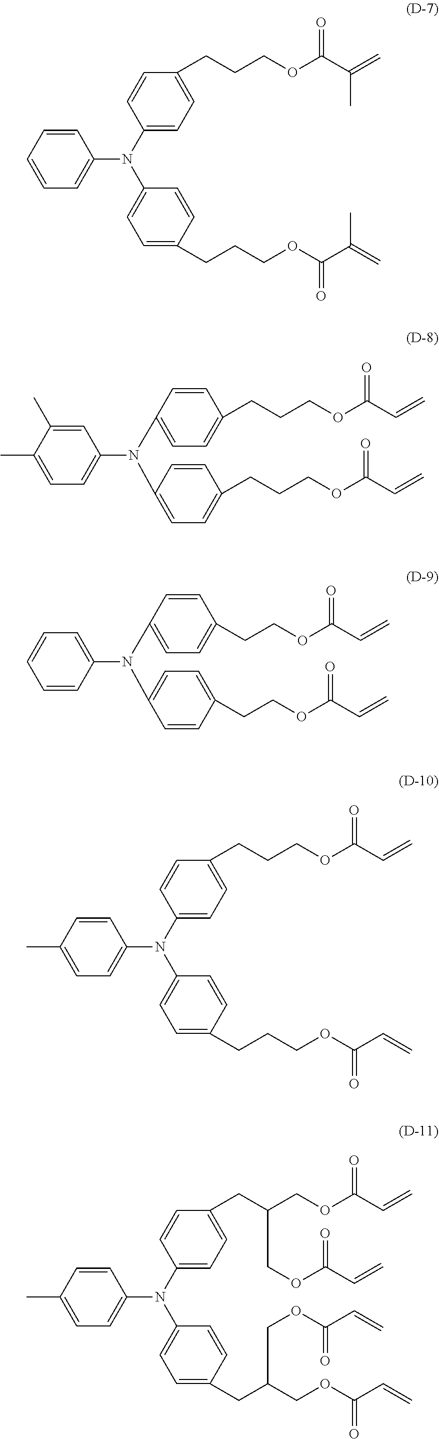

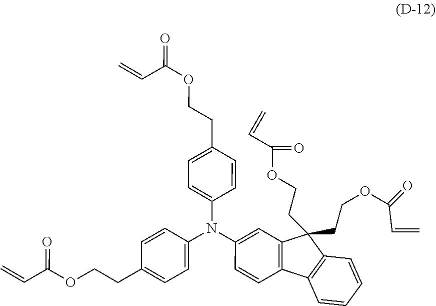

### [Toner]

The toner according to the present disclosure includes a toner particle and an external additive.

Hereinafter, components forming the toner and a method of producing a toner will be described.

### <Method of Producing Toner>

The method of producing a toner particle will be described.

In the method of producing a toner particle, known methods can be used, and a kneading pulverization method or a wet production method can be used. From the viewpoint of uniformity of the particle size and shape controllability, a wet production method can be preferably used. Furthermore, the wet production method includes suspension polymerization, dissolution suspension, emulsion polymerization aggregation, and emulsion aggregation, and emulsion aggregation can be preferably used.

In emulsion aggregation, first, materials such as a fine particle of a binder resin and a fine particle of a colorant are dispersed and mixed in an aqueous medium containing a dispersion stabilizer. The aqueous medium may contain a surfactant. Subsequently, these materials are aggregated into a desired particle size of toner particle by adding a coagulating agent, and subsequently to or simultaneously with aggregation, resin fine particles are fused. Furthermore, fused resin fine particles are optionally subjected to shape control by heat to form a toner particle.

Here, the fine particle of the binder resin can be a composite particle configured with two or more layers formed with resins having different compositions. For example, such fine particle can be produced by emulsion polymerization, miniemulsion polymerization, or phase inversion emulsion or by a combination thereof.

If an internal additive such as a colorant is contained in the toner particle, the internal additive may be contained in the resin fine particle, or a dispersion of an internal additive fine particle composed of the internal additive only may be separately prepared, and the internal additive fine particles may be coaggregated when the resin fine particles are aggregated.

Alternatively, a toner particle configured with layers having different compositions can also be prepared by adding and aggregating resin fine particle having different compositions with some time difference during aggregation.

As the dispersion stabilizer, the followings can be used.

Examples of inorganic dispersion stabilizers include tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina.

Examples of organic dispersion stabilizers include polyvinyl alcohol, gelatin, methyl cellulose, methylhydroxypropyl cellulose, ethyl cellulose, sodium salts of carboxymethyl cellulose, and starch.

As the surfactant, known cationic surfactants, anionic surfactants, and nonionic surfactants can be used.

Specific examples of cationic surfactants include dodecylammonium bromide, dodecyltrimethylammonium bromide, dodecylpyridinium chloride, dodecylpyridinium bromide, and hexadecyltrimethylammonium bromide.

Specific examples of nonionic surfactants include dodecyl polyoxyethylene ether, hexadecyl polyoxyethylene ether, nonyl phenyl polyoxyethylene ether, lauryl polyoxyethylene ether, sorbitan monooleate polyoxyethylene ether, styryl phenyl polyoxyethylene ether, and monodecanoyl sucrose.

Specific examples of anionic surfactants include aliphatic soaps such as sodium stearate and sodium laurate, sodium lauryl sulfate, sodium dodecylbenzenesulfonate, and sodium polyoxyethylene (2) lauryl ether sulfate.

### <Binder Resin>

The binder resin forming the toner particle will be described.

Examples of the binder resin suitably include vinyl resins and polyester resins.

Examples of vinyl resins, polyester resins, and other binder resins include resins or polymers below.

Examples thereof include homopolymers of styrene and substitutes thereof, such as polystyrene and polyvinyltoluene; styrene-based copolymers such as styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-dimethylaminoethyl acrylate copolymers, styrene-methyl methacrylate copolymers, styrene-ethyl methacrylate copolymers, styrene-butyl methacrylate copolymers, styrene-dimethylaminoethyl methacrylate copolymers, styrene-vinyl methyl ether copolymers, styrene-vinyl ethyl ether copolymers, styrene-vinyl methyl ketone copolymers, styrene-butadiene copolymers, styrene-isoprene copolymers, styrene-maleic acid copolymers, and styrene-maleic acid ester copolymers; polymethyl methacrylate, polybutyl methacrylate, polyvinyl acetate, polyethylene, polypropylene, polyvinyl butyral, silicone resins, polyamide resins, epoxy resins, polyacrylic resins, rosin, modified rosin, terpene resin, phenol resins, aliphatic or alicyclic hydrocarbon resins, and aromatic petroleum resins. These binder resins can be used alone or in the form of a mixture.

The binder resin preferably contains a carboxy group, and is preferably a resin prepared from a polymerizable monomer containing a carboxy group. Examples thereof include vinyl carboxylic acids such as acrylic acid, methacrylic acid, α-ethyl acrylic acid, and crotonic acid; unsaturated dicarboxylic acids such as fumaric acid, maleic acid, citraconic acid, and itaconic acid; and unsaturated dicarboxylic acid monoester derivatives such as succinic acid monoacryloyloxy ethyl ester, succinic acid monomethacryloyloxy ethyl ester, phthalic acid monoacryloyloxy ethyl ester, and phthalic acid monomethacryloyloxy ethyl ester.

As the polyester resins, polycondensed products of carboxylic acid components and alcohol components listed below can be used. Examples of the carboxylic acid components include terephthalic acid, isophthalic acid, phthalic acid, fumaric acid, maleic acid, cyclohexanedicarboxylic acid, and trimellitic acid. Examples of the alcohol components include bisphenol A, hydrogenated bisphenol, ethylene oxide adducts of bisphenol A, propylene oxide adducts of bisphenol A, glycerol, trimethylolpropane, and pentaerythritol.

These polyester resins may also be polyester resins having a urea group. The polyester resins preferably have an uncapped terminal carboxy group.

### <Cross-Linking Agent>

To control the molecular weight of the binder resin forming the toner particle, a cross-linking agent may be added during polymerization of the polymerizable monomer.

Examples thereof include ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycols #200, #400, and #600, dipropylene glycol diacrylate, polypropylene glycol diacrylate, polyester-type diacrylate (MANDA NIPPON KAYAKU Co., Ltd.), and these acrylates converted into methacrylates.

The amount of the cross-linking agent to be added is preferably 0.001 to 15.000 parts by mass relative to 100 parts by mass of the polymerizable monomer.

### <Mold Release Agent>

A mold release agent is preferably contained as one of materials forming the toner particle. In particular, because an ester wax having a melting point of 60 to 90° C. has high compatibility with the binder resin, a plastic effect is readily obtained by use thereof.

Examples of the ester wax include waxes containing fatty acid esters as their main components, such as carnauba wax and montanic acid ester wax; and fatty acid esters whose acid components are partially or completely deacidified, such as deacidified carnauba wax; methyl ester compounds having a hydroxy group prepared through hydrogenation of vegetable oils and fats; saturated fatty acid monoesters such as stearyl stearate and behenyl behenate; diesterified products of saturated aliphatic dicarboxylic acids with saturated aliphatic alcohols, such as dibehenyl sebacate, distearyl dodecanedioate, and distearyl octadecanedioate; and diesterified products of saturated aliphatic diols with saturated aliphatic monocarboxylic acids, such as nonanediol dibehenate and dodecanediol distearate.

Among these waxes, a bifunctional ester wax (diester) having two ester bonds in the molecular structure is preferably contained.

The bifunctional ester wax is an ester compound of a divalent alcohol with an aliphatic monocarboxylic acid or an ester compound of a divalent carboxylic acid with an aliphatic monoalcohol.

Specific examples of the aliphatic monocarboxylic acid include myristic acid, palmitic acid, stearic acid, arachidic acid, behenic acid, lignoceric acid, cerotic acid, montanic acid, melissic acid, oleic acid, vaccenic acid, linoleic acid, and linolenic acid.

Specific examples of the aliphatic monoalcohol include myristyl alcohol, cetanol, stearyl alcohol, arachidyl alcohol, behenyl alcohol, tetracosanol, hexacosanol, octacosanol, and triacontanol.

Specific examples of the divalent carboxylic acid include butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), dodecanedioic acid, tridecanedioic acid, tetradecanedioic acid, hexadecanedioic acid, octadecanedioic acid, eicosandioic acid, phthalic acid, isophthalic acid, and terephthalic acid.

Specific examples of the divalent alcohol include ethylene glycol, propylene glycol, 1,3-propanediol, 1,4-butanediol, 1,5-pentanediol, 1,6-hexanediol, 1,10-decanediol, 1,12-dodecanediol, 1,14-tetradecanediol, 1,16-hexadecanediol, 1,18-octadecanediol, 1,20-eicosanediol, 1,30-triacontanediol, diethylene glycol, dipropylene glycol, 2,2,4-trimethyl-1,3-pentanediol, neopentyl glycol, 1,4-cyclohexanedimethanol, spiro glycol, 1,4-phenylene glycol, bisphenol A, and hydrogenated bisphenol A.

Examples of other usable mold release agents include petroleum waxes, such as paraffin wax, microcrystalline wax, and petrolatum, and derivatives thereof; montan wax and derivatives thereof, hydrocarbon waxes prepared by the Fischer-Tropsch method and derivatives thereof, polyolefin waxes, such as polyethylene and polypropylene, and derivatives thereof; natural waxes, such as carnauba wax and candelilla wax, and derivatives thereof; higher aliphatic alcohols; and fatty acids, such as stearic acid and palmitic acid, or compounds thereof.

The content of the mold release agent is preferably 5.0 to 20.0 parts by mass relative to 100.0 parts by mass of the binder resin or the polymerizable monomer.

### <Colorant>

If a colorant is contained in the toner particle, any colorant can be used without limitation, and known colorants shown below can be used.

Examples of yellow pigments to be used include condensed azo compounds, isoindolinone compounds, anthraquinone compounds, azo metal complexes, methine compounds, and allyl amide compounds, such as yellow iron oxide, Naples yellow, Naphthol Yellow S, Hansa Yellow G, Hansa Yellow 10G, benzidine yellow G, benzidine yellow GR, quinoline yellow lake, Permanent yellow NCG, and tartrazine lake. Specifically, examples thereof include the followings.

C.I. Pigment Yellows 12, 13, 14, 15, 17, 62, 74, 83, 93, 94, 95, 109, 110, 111, 128, 129, 147, 155, 168, and 180.

Examples of red pigments include condensed azo compounds, diketopyrrole compounds, anthraquinone compounds, quinacridone compounds, basic dye lake compounds, naphthol compounds, benzimidazolone compounds, thioindigo compounds, and perylene compounds such as red iron oxide, Permanent red 4R, Lithol red, pyrazolone red, watching red calcium salt, lake red C, lake red D, brilliant Carmine 6B, brilliant Carmine 3B, eosin lake, Rhodamine lake B, and alizarin lake. Specifically, examples thereof include the followings.

C.I. Pigment Reds 2, 3, 5, 6, 7, 23, 48:2, 48:3, 48:4, 57:1, 81:1, 122, 144, 146, 166, 169, 177, 184, 185, 202, 206, 220, 221, and 254.

Examples of blue pigments include copper phthalocyanine compounds and derivatives thereof, anthraquinone compounds, and basic dye lake compounds such as alkali blue lake, Victoria blue lake, phthalocyanine blue, metal-free phthalocyanine blue, phthalocyanine blue partial chlorides, fast sky blue, and indanthrene blue BG. Specifically, examples thereof include the followings.

### C.I. Pigment Blues 1, 7, 15, 15:1, 15:2, 15:3, 15:4, 60, 62, and 66.

Examples of black pigments include carbon black and aniline black. These colorants can be used alone, in the form of a mixture, or in the form of a solid solution.

The content of the colorant is preferably 3.0 to 15.0 parts by mass relative to 100.0 parts by mass of the binder resin or the polymerizable monomer.

### <Charge Controlling Agent and Charge Controlling Resin>

The toner particle may contain a charge controlling agent. As the charge controlling agent, known charge controlling agents can be used. In particular, preferred are charge controlling agents which have a high charge speed and can stably maintain a fixed charge amount.

Examples of charge controlling agents which control the toner particle to have negative chargeability include the followings.

Examples of organic metal compounds and chelate compounds as such charge controlling agents include monoazo metal compounds, acetylacetone metal compounds, aromatic oxycarboxylic acids, aromatic dicarboxylic acids, and metal compounds of oxycarboxylic acids and dicarboxylic acids. Other examples of the charge controlling agents include aromatic oxycarboxylic acids, aromatic mono- and polycarboxylic acids, metal salts thereof, anhydrides thereof, and esters thereof, and phenol derivatives thereof such as bisphenol. Further Other examples thereof include urea derivatives, metal-containing salicylic acid compounds, metal-containing naphthoic acid compounds, boron compounds, quaternary ammonium salts, and calixarene.

On the other hand, examples of charge controlling agents which control the toner particle to have positive chargeability include the followings. Examples thereof include nigrosine modified products; guanidine compounds; imidazole compounds; quaternary ammonium salts such as tributylbenzylammonium-1-hydroxy-4-naphthosulfonate salts and tetrabutylammonium tetrafluoroborate, onium salts, such as phosphonium salts which are analogs thereof, and lake pigments thereof, triphenylmethane dyes and lake pigments thereof (examples of laking agents include phosphorus tungstate, phosphorus molybdate, phosphorus tungsten molybdate, tannic acid, lauric acid, gallic acid, ferricyanide, and ferrocyanide); metal salts of higher fatty acids; and resin charge controlling agents.

These charge controlling agent can be contained alone or in combination.

The content of the charge controlling agent is preferably 0.01 to 10.00 parts by mass relative to 100.00 parts by mass of the binder resin or the polymerizable monomer.

### <External Additive>

The toner according to the present disclosure needs to contain a hydrotalcite particle as an additive, and the hydrotalcite particle needs to contain fluorine in filter fitting analysis in STEM-EDS analysis.

The hydrotalcite particle is generally represented by Structural Formula (1):

M²⁺_{y}M³⁺ₓ(OH)₂Aⁿ⁻_{(x/n)}·mH₂O Formula (1)

where 0<x≤0.5, y=1−x, and m≥0.

M²⁺ and M³⁺ each represent a divalent metal and a trivalent metal, respectively.

M²⁺ is preferably at least one divalent metal ion selected from the group consisting of Mg, Zn, Ca, Ba, Ni, Sr, Cu, and Fe. M³⁺ is preferably at least one trivalent metal ion selected from the group consisting of Al, B, Ga, Fe, Co, and In.

Aⁿ⁻ is an n-valent anion, and examples thereof include CO₃²⁻, OH⁻, Cl⁻, I⁻, F⁻, Br⁻, SO₄²⁻, HCO₃⁻, CH₃COO⁻, and NO₃⁻. These may be present alone or in combination.

The hydrotalcite particle according to the present disclosure contains fluorine. Fluorine can be contained in the hydrotalcite particle by any method without limitation, and examples of methods include a method of treating the hydrotalcite particle with a coupling treatment agent containing fluorine, and a method of treating the hydrotalcite particle in an aqueous solution containing fluoride ions. From the viewpoint of uniform treatment, preferred is a method of performing wet treatment in an aqueous solution containing fluoride ions. In the present disclosure, the divalent metal ion M²⁺ preferably contains magnesium, and the trivalent metal ion M³⁺ preferably contains aluminum. In other words, hydrotalcite particle according to the present disclosure preferably contains fluorine, magnesium, and aluminum.

The hydrotalcite particle may be a solid solution containing several different elements. The hydrotalcite particle may contain a trace of a monovalent metal.

The primary particles of the hydrotalcite particle have a number average particle size of preferably 60 to 1000 nm, more preferably 60 to 800 nm.

If the primary particles of the hydrotalcite particle have a number average particle size of more than 1000 nm, the fluidity of the toner is likely to reduce, resulting in a reduction in charging properties during durability tests.

Separately from the fluorine treatment, the hydrotalcite particle may be hydrophobized with a surface treatment agent. Examples of surface treatment agents to be used include higher fatty acids, coupling agents, esters, and silicone oil. Among these, higher fatty acids are preferably used, and specifically, examples thereof include stearic acid, oleic acid, and lauryl acid.

The hydrotalcite particle preferably contains magnesium and aluminum in filter fitting analysis in STEM-EDS analysis.

Preferably, in the hydrotalcite particle, fluorine is present inside the hydrotalcite particle in line analysis in STEM-EDS analysis. If fluorine is present inside the hydrotalcite particle, the hydrotalcite particle migrates onto the surface of the photosensitive member, and when discharge products are taken into the interlayer, fluorine migrates onto the surface of the photosensitive member through ion exchange. Thereby, fluorine suppresses absorption of moisture onto the surface of the photosensitive member to reduce solution cross-linking caused between the discharge products on the surface of the photosensitive member and the toner. Thus, the adhesive force between the surface of the photosensitive member and the toner is reduced, and the transfer properties can be further improved.

When the elastic deformation rate of the surface layer in the photosensitive member is defined as η [%] and the proportion of the hydrotalcite particle to the toner in the toner is defined as q [% by mass], η and q preferably satisfy the relation represented by Expression (A) below:

100≤η/q≤300 Expression (A).

If η and q satisfy the relation represented by Expression (A) above, the positive charge of the hydrotalcite particle can be more efficiently weakened when the toner receives friction in the contact portion between the photosensitive member and the developing member.

### <Method of Identifying Hydrotalcite Particle>

Identification of hydrotalcite particle as an external additive can be performed by observation of the shapes thereof with a scanning electron microscope (SEM) in combination with elemental analysis by energy dispersive X-ray analysis (EDS).

The toner is observed in a field enlarged to 50000× at maximum using a scanning electron microscope “S-4800” (trade name; available from Hitachi, Ltd.). The surface of a toner particle is focused to observe the external additive to be identified. The external additive to be identified is subjected to EDS analysis, and identification of hydrotalcite particle can be performed from the types of element peaks.

If as element peaks, an element peak of at least one metal selected from the group consisting of Mg, Zn, Ca, Ba, Ni, Sr, Cu, and Fe which can form a hydrotalcite particle and an element peak of at least one metal selected from the group consisting of Al, B, Ga, Fe, Co, and In are observed, the presence of hydrotalcite particle containing the two metals can be inferred.

A sample of hydrotalcite particle inferred based on the EDS analysis is separately prepared, and is subjected to observation of the shape with an SEM and by EDS analysis. The results obtained from the analysis of the sample are compared to those obtained from the analysis of the particle to be identified to determine whether the particle to be identified is a hydrotalcite particle.

### [Charging Member]

The process cartridge according to the present disclosure may include a charging member, namely, a charging roller.

In the configuration of the present disclosure, a charging roller having reduced surface roughness can suppress generation of transfer residual toner. Specifically, the charging roller preferably has a ten-point average surface roughness Rz of the outer circumferential surface of 5 to 20 μm.

If the charging roller has an average surface roughness Rz of 10 points on the outer circumferential surface controlled to 20 μm or less, the size of convex portions present on the surface of the charging roller can be reduced. Furthermore, the charging roller preferably has an average surface roughness Rz of 10 points on the outer circumferential surface of 15 μm or less.

Here, the convex portions on the surface of the charging roller indicates convex portions 3 μm or larger than the average of surface heights obtained from the profile of the surface shape of the charging roller, which is obtained with a means such as a laser microscope or a contact-type roughness meter.

In the discharging step, the photosensitive member is charged by generating discharge in the air through application of an electric field beyond the Paschen's law in a small gap between the charging roller and the photosensitive member. Because the convex portions on the surface of the charging roller are closer to the photosensitive member than their surroundings and the electric field is more likely to concentrate on the convex portions due to their shape, the amount of the discharge current is larger than those of the surroundings. As a result, the surface potential formed on the surface of the photosensitive member by discharge from the convex portions is higher than the surface potential formed by discharge from the surroundings of the convex portions.

In the photosensitive member, a toner with an inverted polarity (toner having a polarity opposite to the polarity needed for development) is likely to be developed in portions of the photosensitive member having a high surface potential in the developing step. The toner with an inverted polarity becomes a transfer residual toner because electrostatic attraction acts thereon also in the transferring step such that the toner is left on the photosensitive member.

Accordingly, a reduction in height of the convex portions present on the surface of the charging roller and a reduction in surface roughness Rz enable a suppression in generation of the transfer residual toner on the photosensitive member.

Examples of the method of measuring the ten-point average surface roughness Rz of the charging roller include a method of measuring using an apparatus which can appropriately measure the control range of the surface roughness in the present disclosure, such as a laser microscope or a contact-type surface roughness meter.

The method of controlling the ten-point average surface roughness Rz of the charging roller can be appropriately selected from a method of controlling the ten-point average surface roughness Rz by the conditions during formation of the electroconductive layer (extrusion, polishing, and formation of the surface layer) and a method of adding a roughness forming material such as a resin particle or an inorganic particle to the electroconductive layer, and controlling the particle size and the amount of the particle to be added. Among these, preferred is a method of adding a resin particle as a roughness forming material to the electroconductive layer to form the layer, because it can reduce the area of the surface of the charging roller where the convex portions are present.

Hereinafter, a charging roller as the charging member according to the present disclosure will be described in detail.

The charging roller is preferably configured to include an electroconductive support, and an electroconductive layer on the outer circumferential surface of the electroconductive support. The electroconductive layer may be formed of mainly a resin material or a rubber material, and is preferably an electroconductive elastic layer containing a rubber material for suitable contact with the photosensitive member.

The electroconductive elastic layer can have a configuration appropriately selected from a single electroconductive elastic layer and two or more electroconductive elastic layers on the outer circumferential surface of the electroconductive support in the range allowing demonstration of the effects of the present disclosure.

### <Electroconductive Support>

The material to be used to form the electroconductive support can be appropriately selected from known materials in the field of the electrophotographic electroconductive member and materials which can be used as such an electroconductive member. As one example, examples thereof include aluminum, stainless steel, synthetic resins having conductivity, and metals and alloys thereof such as iron and copper alloys. Furthermore, these materials may be subjected to an oxidation treatment or plating with chromium or nickel. As the type of plating, any one of electrical plating and electroless plating can be used. From the viewpoint of dimensional stability, electroless plating is preferred. Examples of the types of electroless plating used here include nickel plating, copper plating, gold plating, and plating with a variety of alloys. The plating thickness is preferably 0.05 μm or more. Considering the balance between work efficiency and anti-corrosive ability, the plating thickness is more preferably 0.1 to 30 μm. If the support has a cylindrical shape, the support may be solid and cylindrical, or may be hollow and cylindrical (tubal). The support preferably has an outer diameter in the range of ϕ3 mm to ϕ10 mm.

For suitable contact with the photosensitive member, the material forming the electroconductive elastic layer is preferably mainly formed of a rubber material. An electroconductive agent for imparting conductivity and other fillers may be added in the range not inhibiting the effects of the present disclosure. These materials to be used can be appropriately selected from known materials in the field of the electrophotographic electroconductive member and materials which can be used as such an electroconductive member, and are listed below.

### <Rubber Material>

Specific examples of rubber materials forming the electroconductive elastic layer include raw material rubbers such as natural rubber (NR), isoprene rubber (IR), butadiene rubber (BR), styrene-butadiene rubber (SBR), butyl rubber (IIR), ethylene-propylene-diene terpolymer rubber (EPDM), epichlorohydrin homopolymer (CHC), epichlorohydrin-ethylene oxide copolymer (CHR), epichlorohydrin-ethylene oxide-allyl glycidyl ether terpolymer (CHR-AGE), acrylonitrile-butadiene copolymer (NBR), hydrogenated products of acrylonitrile-butadiene copolymer (H-NBR), chloroprene rubber (CR), and acrylic rubbers (ACM and ANM); and liquid rubbers such as liquid butadiene rubber and liquid styrene butadiene rubber. These can be used alone or in combination.

### <Electroconductive Material>

As the electroconductive material imparting conductivity to the electroconductive elastic layer, an electroconductive material such as an ionic electroconductive agent or an electronic electroconductive agent can be appropriately compounded.

Examples of ionic electroconductive agents include the followings. Examples thereof include inorganic ion substances such as lithium perchlorate, sodium perchlorate, and calcium perchlorate; cationic surfactants such as lauryltrimethylammonium chloride, stearyltrimethylammonium chloride, octadecyltrimethylammonium chloride, dodecyltrimethylammonium chloride, hexadecyltrimethylammonium chloride, trioctylpropylammonium bromide, and modified aliphatic dimethylethylammonium ethosulfate; amphoteric ion surfactants such as lauryl betaine, stearyl betaine, and dimethyl alkyl lauryl betaine; quaternary ammonium salts such as tetraethylammonium perchlorate, tetrabutylammonium perchlorate, and trimethyloctadecylammonium perchlorate; and organic acid lithium salts such as lithium trifluoromethanesulfonate. These can be used alone or in combination.

Examples of electronic electroconductive agents include the followings. Examples thereof include metal fine particles and fibers of aluminum, palladium, iron, copper, and silver; and metal oxides such as titanium oxide, tin oxide, and zinc oxide, which are treated to have conductivity; composite particles having surfaces of the metal fine particles and fibers and the metal oxides which are surface treated by electrolysis, spray coating, or mixing with shaking; carbon powders such as furnace black, thermal black, acetylene black, ketjen black, PAN (polyacrylonitrile) carbon, and pitch carbon. Examples of furnace black include the followings. Examples thereof include SAF-HS, SAF, ISAF-HS, ISAF, ISAF-LS, I-ISAF-HS, HAF-HS, HAF, HAF-LS, T-HS, T-NS, MAF, FEF, GPF, SRF—HS—HM, SRF-LM, ECF, and FEF-HS. Examples of thermal black include FT and MT. Among these, preferred are carbon black because it is relatively easily available and provides favorable conductivity.

### <Other Additives>

The electroconductive elastic layer may optionally contain a filler, a processing aid, an anti-aging agent, a cross-linking aid, a cross-linking accelerator, a cross-linking accelerating aid, a cross-linking retarder, a dispersant, a foaming agent, a resin particle, and an inorganic particle, which are usually used as compounding agents for rubber.

### <Resin Particle>

The electroconductive elastic layer may contain a resin particle or an inorganic particle. For suitable contact with the photosensitive member and suitable rotation, preferred is a resin particle. Examples of materials for the resin particle to be used include known resins in the field of the electrophotographic electroconductive member, such as resins such as polyurethane resins, polyester resins, polyethylene resins, polyether resins, polyamide resins, acrylic resins, and phenol resins.

### <Method of Producing Electroconductive Elastic Layer>

As an exemplary method of producing the electroconductive elastic layer, the electroconductive elastic layer can be produced as follows: The rubber material, the electroconductive material, and other additives described above are mixed using a closed-type mixer such as a Banbury mixer or a pressurized kneader or an open-type mixer such as an open roll mill, and are formed into an unvulcanized electroconductive elastic layer on the outer circumferential surface of the electroconductive support by a method of extrusion molding, injection molding, or molding. In the next step, the unvulcanized electroconductive elastic layer is vulcanized and cured by heating or the like, followed by a polishing step and the surface treatment step.

### <Method of Controlling Ten-Point Average Surface Roughness Rz of Electroconductive Elastic Layer>

If the charging roller is configured with an electroconductive support and an electroconductive elastic layer formed on the outer circumferential surface of the electroconductive support, the ten-point average surface roughness Rz of the charging roller can be controlled by the following method. One example of the method of controlling the surface roughness may be a method of adding a resin particle to the rubber material, and exposing part of the resin particle from the surface of the charging roller by removing the rubber material in the polishing step. Another example may be a method of using the shape of the surface formed during extrusion molding of the rubber material, or may be a method of controlling the shape of the surface by further processing.

Among these, preferred is a method of adding a resin particle to the rubber material, and exposing the resin particle from the surface of the charging roller by the polishing step because the convex portions which have strong discharge and causes the transfer residual toner can be independently present on the surface of the charging roller.

Although the resin particle added to the electroconductive elastic layer can have any particle size in the range as long as they can be suitably mixed with the rubber material, preferably the average particle size is 10 to 25 μm because part of the resin particle can be exposed by polishing in the polishing step and the ten-point average surface roughness Rz of the charging roller is readily controlled to the range enabling suppression of the transfer residual toner (5 to 20 μm).

Although the resin particle can be added to the electroconductive elastic layer in any amount as long as they can be suitably mixed with the rubber material, the amount is preferably 5 to 30 parts by mass relative to 100 parts by mass of the rubber material because the ten-point average surface roughness Rz of the charging roller is readily controlled to the range enabling suppression of the transfer residual toner (5 to 20 μm).

### <Electroconductive Surface Layer>

Furthermore, as described below, an electroconductive surface layer may be further formed on the outer circumferential surface of the electroconductive elastic layer formed as described above.

If the charging roller has a two-layered configuration, the material for forming the electroconductive surface layer to be further formed on the outer circumferential surface of the electroconductive elastic layer formed on the outer circumferential surface of the electroconductive support contains a binder resin and an electroconductive material imparting conductivity. This material can be used in combination with other additives in the range not inhibiting the effects of the present disclosure. These constitutional materials to be used can be appropriately selected from known materials in the field of the electrophotographic electroconductive member and materials which can be used as such an electroconductive member.

### <Binder Resin>

As a material for the binder resin forming the electroconductive surface layer, a known resin in the field of the electrophotographic electroconductive member can be used. Examples thereof include resins, and rubbers such as natural rubber, vulcanized natural rubber, and synthetic rubber. Examples of usable resins include epoxy resins, urethane resins, urea resins, ester resins, amide resins, imide resins, amide-imide resins, phenol resins, vinyl resins, silicone resins, fluorinated resins, acrylic resins, and butyral resins. A copolymer prepared from two or more of monomers serving as raw materials for these resins can also be used.

### <Electroconductive Material>

As the electroconductive material imparting conductivity to the electroconductive surface layer, the same materials as those described above as the usable electroconductive materials for the electroconductive elastic layer can also be used.

### <Resin Particle>

Examples of a method of controlling the ten-point average surface roughness of the surface of the charging roller with the electroconductive surface layer include a method of adding a resin particle or an inorganic particle which can serve as a roughening particle to the electroconductive surface layer. For suitable contact with the photosensitive member and suitable rotation, preferred is a resin particle.

Examples of roughening particle include the followings. Examples of usable materials for the roughening particle include organic insulative particles such as known resins in the field of the electrophotographic electroconductive member, acrylic resins, polycarbonate resins, styrene resins, urethane resins, fluorinated resins, and silicone resins; and inorganic insulative particles such as titanium oxide, silica, alumina, magnesium oxide, strontium titanate, barium titanate, barium sulfate, calcium carbonate, mica, zeolite, and bentonite. In the present disclosure, preferred is use of an organic insulative particle having flexibility as the roughening particle because it can reduce the distance between the convex portions and the photosensitive member in the discharge portion. These particles may be used alone or in combination.

### <Method of Controlling Ten-Point Average Surface Roughness of Electroconductive Surface Layer in Charging Roller>

Examples of the method of controlling the ten-point average surface roughness Rz of the charging roller with the roughening particle of the electroconductive surface layer include a method of adjusting the particle size of the roughening particle and the number of parts thereof to be added.

Here, the particle size of the roughening particle indicates the number average particle size of the roughening particles, and is preferably about 3 to about 30 μm because the ten-point average surface roughness Rz of the charging roller is readily controlled in the range enabling suppression of the transfer residual toner (5 to 20 μm).

Although the roughening particle can be added to the electroconductive surface layer in any amount as long as they can be suitably mixed with the binder resin, the amount is preferably 5 to 30 parts by mass relative to 100 parts by mass of the binder resin because the ten-point average surface roughness Rz of the charging roller is readily controlled in the range enabling suppression of the transfer residual toner (5 to 20 μm).

### <Other Additives>

The electroconductive surface layer of the charging roller may optionally contain other additives in the range not imparting the effects of the present disclosure. To increase the resistance of the surface layer and impart slip properties, a silicone additive is preferably contained. Furthermore, a modified functional group or chain may be introduced, or a surface treatment with a coating or a mold release agent may be performed.

### <Thickness of Electroconductive Surface Layer in Charging Roller>

The electroconductive surface layer preferably has a thickness of 0.1 μm or more and 100 μm or less. The electroconductive surface layer more preferably has a thickness of 1 to 50 μm. The thickness of the surface layer can be measured by cutting out a cross-section of the charging roll with a sharp knife and observing the cross-section with an optical microscope or an electron microscope.

### <Method of Producing Electroconductive Surface Layer of Charging Roller>

Examples of the method of forming the electroconductive surface layer include, but should not be limited to, spraying, immersion, or roll coating of a coating material prepared by adding a solvent to raw materials. The immersion coating method has excellent production stability as the method of forming the electroconductive surface layer. After coating, the resulting coating may be optionally subjected to an additional treatment such as heating.

### [Process Cartridge, Electrophotographic Apparatus]

The process cartridge according to the present disclosure integrally supports the above-mentioned electrophotographic photosensitive member and at least one unit selected from a charging unit, a developing unit, a transfer unit, and a cleaning unit, and is detachably attachable to the body of the electrophotographic apparatus.

The electrophotographic apparatus according to the present disclosure includes the above-mentioned electrophotographic photosensitive member, a charging unit, an exposing unit, a developing unit, and a transfer unit.

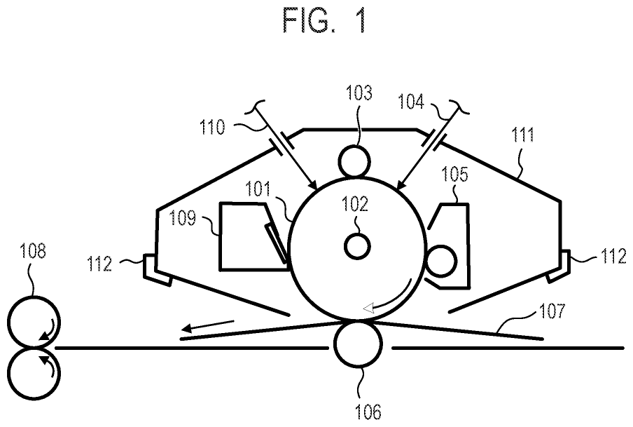

FIG. 1 shows one example of the schematic configuration of the electrophotographic apparatus including a process cartridge including an electrophotographic photosensitive member.

A cylindrical electrophotographic photosensitive member 101 is driven and rotated around a shaft 102 in the arrow direction at a predetermined circumferential speed. The surface of the electrophotographic photosensitive member 101 is charged by a charging unit 103 to a predetermined positive or negative potential. Although a roll charging method by a roll-type charging member is shown in the drawing, a charging method such as a corona charging method, a close contact charging method, or an injection charging method may be used. The charged surface of the electrophotographic photosensitive member 101 is irradiated with exposing light 104 from an exposing unit (not illustrated) to form an electrostatic latent image corresponding to information on the target image. The electrostatic latent image formed on the surface of the electrophotographic photosensitive member 101 is developed with a toner accommodated in a developing unit 105 to form a toner image on the surface of the electrophotographic photosensitive member 101. The toner image formed on the surface of the electrophotographic photosensitive member 101 is transferred onto a transfer material 107 by a transfer unit 106. The transfer material 107 having the transferred toner image is conveyed to a fixing unit 108, where the toner image is fixed, and is printed out of the electrophotographic apparatus. The electrophotographic apparatus may include a cleaning unit 109 for cleaning adhering substances such as a residual toner left on the surface of the electrophotographic photosensitive member 101 after the transfer. Alternatively, the cleaning unit is not separately disposed, and a so-called cleanerless system which removes the adhering substances with the developing unit may be used. The electrophotographic apparatus may include an anti-static mechanism which removes electricity from the surface of the electrophotographic photosensitive member 101 with pre-exposure light 110 from a pre-exposing unit (not illustrated). A guide unit 112 such as a rail may be disposed to attach and detach the process cartridge 111 according to the present disclosure to and from the body of the electrophotographic apparatus.

The electrophotographic photosensitive member according to the present disclosure can be used in laser beam printers, LED printers, and copiers.

### EXAMPLES

Hereinafter, the present disclosure will be described in more detail by way of Examples and Comparative Examples. The present disclosure is not limited by the Examples below without departing from the gist thereof. In the description in Examples below, “parts” are mass-based unless otherwise specified.

### <Production of Electrophotographic Photosensitive Member>

### Method of Producing [Photosensitive Member 1]

### Support

An aluminum tube having a thickness of 1 mm, a length of 257 mm, and a diameter of 24 mm and having a mirror-finished surface was degreased and washed at 60° C. for 5 minutes in a solution of 30 g of a degreasing agent (available from Kizai Corporation, trade name NG-#30) dissolved in 11 of water. In the next step, the aluminum tube was washed with water, was immersed in 6% nitric acid at 25° C. for 1 minute, and was further washed with water. An anodic oxidation treatment was performed in an electrolyte solution of 180 g/l sulfuric acid (dissolved aluminum ion concentration: 7 g/l) at a current density of 0.8 A/dm² to form an anode oxidation film having an average thickness of 4.5 μm. In the next step, after washed with water, the aluminum tube was immersed in an aqueous solution at 95° C. for 30 minutes, the aqueous solution being prepared by dissolving 10 g of a high-temperature pore sealer (available from OKUNO Chemical Industries Co., Ltd., trade name TOP SEAL DX-500) containing nickel acetate as the main component in 1 l of water, thereby sealing pores thereof. Furthermore, the aluminum tube was ultrasonically washed, and was dried, and was used as the electroconductive support.

### Charge-Generating Layer

Next, 10 parts of a polyvinyl butyral resin (trade name: S-LEC BX-1, available from Sekisui Chemical Co., Ltd.) was dissolved in 600 parts of cyclohexanone. As a charge generating material, 15 parts of oxytitanium phthalocyanine crystals having a strong peak at a Bragg angle 2θ±0.2° of 27.3° in CuKα, characteristic X-ray diffraction was added to this solution. The solution was placed into a sand mill containing glass beads having a diameter of 1 mm, and was dispersed for 4 hours. Thereafter, 600 parts of ethyl acetate was added to prepare a coating solution for a charge generating layer. This coating solution for a charge generating layer was applied onto the support by immersion coating, and the resulting coating was dried at 80° C. for 15 minutes to form a charge generating layer having a thickness of 0.20 μm.

### Charge Transport Layer

Next, 75 parts of a compound (charge transport material) represented by Formula (CTM-1) below and 75 parts of a biphenyl copolymerized polycarbonate resin (weight average molecular weight: 30000) including a structural unit represented by (Binder-1) and a structural unit represented by (Binder-2) in a mass ratio of 9:1 were dissolved in a mixed solvent of 340 parts of toluene and 200 parts of tetrahydrofuran to prepare a coating solution for a charge transport layer.

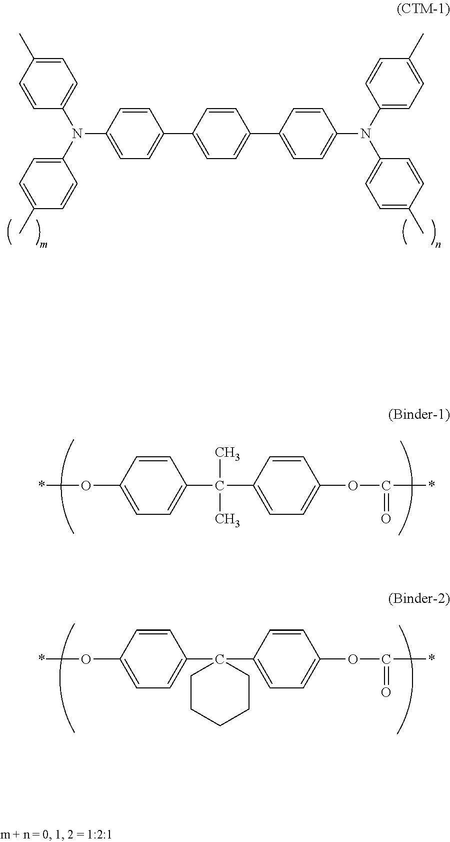

This coating solution for a charge transport layer was applied onto the charge generating layer by immersion coating to form a coating, and the resulting coating was dried at 120° C. for 60 minutes to form a charge transport layer having a thickness of 25.5 μm.

### Protective Layer

Next, the following materials were prepared.
compound represented by Formula (D-6) above as OCL Monomer 1 25 parts
compound represented by Formula (B-1) above as OCL Monomer 2 75 parts
   These were mixed with a mixed solvent of 360 parts of 2-propanol and 40 parts of tetrahydrofuran, followed by stirring. Thus, a coating solution for a protective layer was prepared.

This coating solution for a protective layer was applied onto the charge transport layer by immersion coating to form a coating, and the resulting coating was dried at 50° C. for 6 minutes. Subsequently, under a nitrogen atmosphere, the coating was irradiated with an electron beam for 2.0 seconds at an accelerating voltage of 70 kV and a beam current of 5.0 mA while the support (body to be irradiate) was being rotated at a rate of 300 rpm. The dose in the protective layer position was 14 kGy. Subsequently, under a nitrogen atmosphere, the temperature of the coating was increased to 120° C. The oxygen concentration from the irradiation with the electron beam to the subsequent heat treatment was 15 ppm. Next, the coating was spontaneously cooled in the air until the temperature of the coating reached 25° C., and then was heat treated for 1 hour under a condition such that the temperature of the coating reached 120° C., thereby forming a protective layer having a thickness of 3.5 μm. Thus, Photosensitive member 1 was prepared.

Methods of producing [Photosensitive member 2] to [Photosensitive member 31] and [Comparative Photosensitive member 1] to [Comparative Photosensitive member 12]

In the method of producing [Photosensitive member 1], the materials for the protective layer, the number of parts thereof, and the conditions for irradiation of the protective layer with the electron beam were varied as shown in Table 1 below. Except for these, [Photosensitive member 2] to [Photosensitive member 31] and [Comparative Photosensitive member 1] to [Comparative Photosensitive member 12] were produced in the same manner as in the method of producing [Photosensitive member 1].

Formulae (E-1) to (E-4), Formulae (F-1) to (F-3), and Formulae (G-1) to (G-2) in Table 1 are shown below.

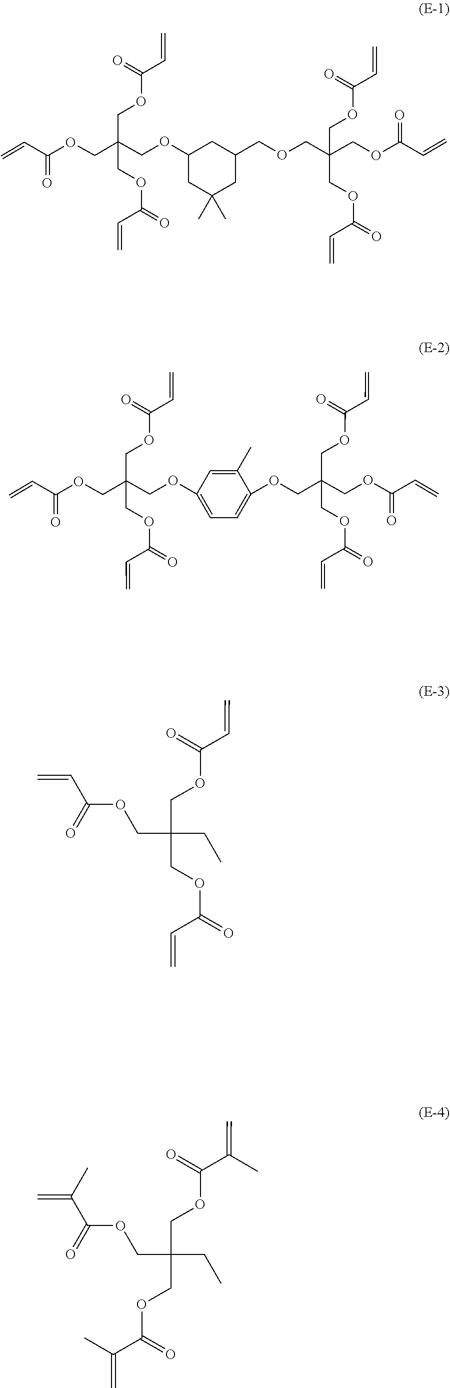

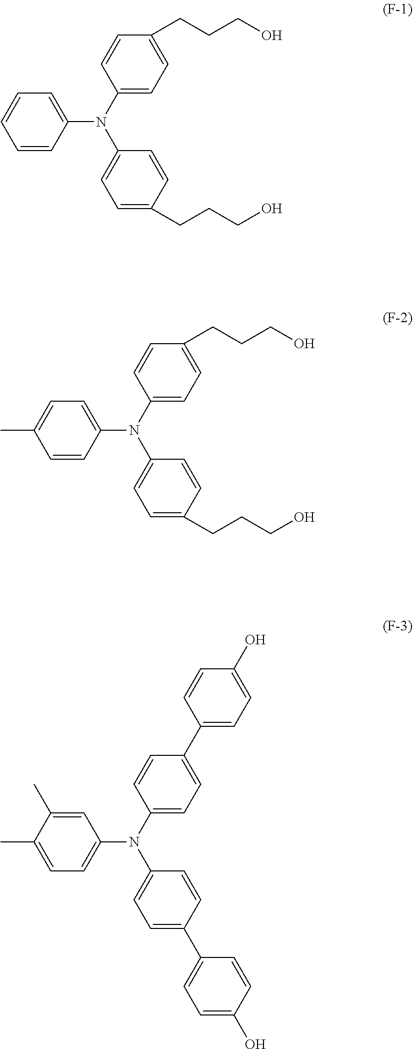 [SMILES: OCCCc1ccc(N(c2ccccc2)c2ccc(CCCO)cc2)cc1 ; Cc1ccc(N(c2ccc(CCCO)cc2)c2ccc(CCCO)cc2)cc1 ; Cc1ccc(N(c2ccc(-c3ccc(O)cc3)cc2)c2ccc(-c3ccc(O)cc3)cc2)cc1C]

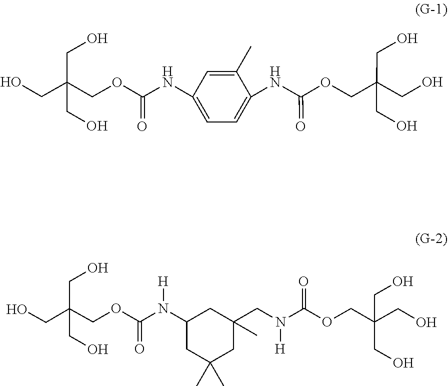 [SMILES: Cc1cc(NC(=O)OCC(CO)(CO)CO)ccc1NC(=O)OCC(CO)(CO)CO ; CC1(C)CC(NC(=O)OCC(CO)(CO)CO)CC(C)(CNC(=O)OCC(CO)(CO)CO)C1]

TABLE 1

| | | | | | | | | | Heating | | Dose at | | | |
|---|---|---|---|---|---|---|---|---|---|---|---|---|---|---|
| | | | | | | | | | in low | | position | | | |
| | OCL | | OCL | | Oxygen | Volt- | Cur- | Time | oxygen | Heat- | of pro- | Ure- | | Elastic |
| | monomer 1 | | monomer 2 | | concen- | age | rent | for | concen- | ing | tective | thane | | deforma- |
| Photosensitive | Mate- | | Mate- | | tration/ | value/ | value/ | irradi- | tration/ | in air/ | layer/ | struc- | (Meth)acrylic | tion |
| member | rial | Parts | rial | Parts | ppm | kV | mA | ation/s | ° C. | ° C. | kGy | ture | resin | rate |
| Photosensitive | D-6 | 25 | B-1 | 75 | 15 | 70 | 5 | 2 | 120 | 120 | 14 | Present | Present | 54 |
| member 1 | | | | | | | | | | | | | | |
| Photosensitive | D-6 | 35 | B-1 | 65 | 15 | 70 | 5 | 2 | 120 | 120 | 14 | Present | Present | 52 |
| member 2 | | | | | | | | | | | | | | |
| Photosensitive | D-6 | 50 | B-1 | 50 | 15 | 70 | 5.0 | 2.0 | 120 | 120 | 14 | Present | Present | 52 |
| member 3 | | | | | | | | | | | | | | |
| Photosensitive | D-6 | 65 | B-1 | 35 | 15 | 70 | 5.0 | 2.0 | 120 | 120 | 14 | Present | Present | 49 |
| member 4 | | | | | | | | | | | | | | |
| Photosensitive | D-6 | 80 | B-1 | 20 | 15 | 70 | 5.0 | 2.0 | 120 | 120 | 14 | Present | Present | 46 |
| member 5 | | | | | | | | | | | | | | |
| Photosensitive | D-6 | 85 | B-1 | 15 | 15 | 70 | 5.0 | 2.0 | 120 | 120 | 14 | Present | Present | 44 |
| member 6 | | | | | | | | | | | | | | |
| Photosensitive | D-7 | 25 | B-13 | 75 | 15 | 70 | 5.0 | 2.0 | 120 | 120 | 14 | Present | Present | 54 |
| member 7 | | | | | | | | | | | | | | |
| Photosensitive | D-7 | 50 | B-13 | 50 | 15 | 70 | 5.0 | 2.0 | 120 | 120 | 14 | Present | Present | 53 |
| member 8 | | | | | | | | | | | | | | |
| Photosensitive | D-7 | 75 | B-13 | 25 | 15 | 70 | 5.0 | 2.0 | 120 | 120 | 14 | Present | Present | 49 |
| member 9 | | | | | | | | | | | | | | |
| Photosensitive | D-6 | 25 | B-14 | 75 | 15 | 70 | 5.0 | 2.0 | 120 | 120 | 14 | Present | Present | 49 |
| member 10 | | | | | | | | | | | | | | |
| Photosensitive | D-6 | 35 | B-14 | 65 | 15 | 70 | 5.0 | 2.0 | 120 | 120 | 14 | Present | Present | 49 |
| member 11 | | | | | | | | | | | | | | |
| Photosensitive | D-6 | 50 | B-14 | 50 | 15 | 70 | 5.0 | 2.0 | 120 | 120 | 14 | Present | Present | 49 |
| member 12 | | | | | | | | | | | | | | |
| Photosensitive | D-6 | 60 | B-14 | 40 | 15 | 70 | 5.0 | 2.0 | 120 | 120 | 14 | Present | Present | 45 |
| member 13 | | | | | | | | | | | | | | |
| Photosensitive | D-6 | 65 | B-14 | 35 | 15 | 70 | 5.0 | 2.0 | 120 | 120 | 14 | Present | Present | 44 |
| member 14 | | | | | | | | | | | | | | |
| Photosensitive | D-6 | 80 | B-14 | 20 | 15 | 70 | 5.0 | 2.0 | 120 | 120 | 14 | Present | Present | 41 |
| member 15 | | | | | | | | | | | | | | |
| Photosensitive | D-1 | 50 | B-1 | 50 | 15 | 70 | 5.0 | 2.0 | 120 | 120 | 14 | Present | Present | 47 |
| member 16 | | | | | | | | | | | | | | |
| Photosensitive | D-4 | 50 | B-1 | 50 | 15 | 70 | 5.0 | 2.0 | 120 | 120 | 14 | Present | Present | 45 |
| member 17 | | | | | | | | | | | | | | |
| Photosensitive | D-8 | 50 | B-1 | 50 | 15 | 70 | 5.0 | 2.0 | 120 | 120 | 14 | Present | Present | 51 |
| member 18 | | | | | | | | | | | | | | |
| Photosensitive | D-10 | 50 | B-1 | 50 | 15 | 70 | 5.0 | 2.0 | 120 | 120 | 14 | Present | Present | 52 |
| member 19 | | | | | | | | | | | | | | |
| Photosensitive | D-12 | 50 | B-1 | 50 | 15 | 70 | 5.0 | 2.0 | 120 | 120 | 14 | Present | Present | 54 |
| member 20 | | | | | | | | | | | | | | |
| Photosensitive | D-1 | 50 | B-5 | 50 | 15 | 70 | 5.0 | 2.0 | 120 | 120 | 14 | Present | Present | 48 |
| member 21 | | | | | | | | | | | | | | |
| Photosensitive | D-4 | 50 | B-5 | 50 | 15 | 70 | 5.0 | 2.0 | 120 | 120 | 14 | Present | Present | 45 |
| member 22 | | | | | | | | | | | | | | |
| Photosensitive | D-4 | 55 | B-5 | 45 | 15 | 70 | 5.0 | 2.0 | 120 | 120 | 14 | Present | Present | 43 |
| member 23 | | | | | | | | | | | | | | |
| Photosensitive | D-10 | 50 | B-5 | 50 | 15 | 70 | 5.0 | 2.0 | 120 | 120 | 14 | Present | Present | 52 |
| member 24 | | | | | | | | | | | | | | |
| Photosensitive | D-11 | 50 | B-5 | 50 | 15 | 70 | 5.0 | 2.0 | 120 | 120 | 14 | Present | Present | 54 |
| member 25 | | | | | | | | | | | | | | |
| Photosensitive | D-12 | 50 | B-5 | 50 | 15 | 70 | 5.0 | 2.0 | 120 | 120 | 14 | Present | Present | 54 |
| member 26 | | | | | | | | | | | | | | |
| Photosensitive | D-6 | 50 | B-1 | 50 | 15 | 110 | 12 | 2.5 | 120 | 120 | 90 | Present | Present | 54 |
| member 27 | | | | | | | | | | | | | | |
| Photosensitive | D-6 | 50 | B-1 | 50 | 15 | 70 | 5.0 | 0.4 | 120 | 120 | 3 | Present | Present | 46 |
| member 28 | | | | | | | | | | | | | | |
| Photosensitive | D-6 | 50 | B-1 | 50 | 15 | 70 | 5.0 | 0.4 | Not | 120 | 3 | Present | Present | 43 |
| member 29 | | | | | | | | | performed | | | | | |
| Photosensitive | D-6 | 50 | B-1 | 50 | 15 | 70 | 5.0 | 5.0 | 120 | 120 | 35 | Present | Present | 53 |
| member 30 | | | | | | | | | | | | | | |
| Photosensitive | D-6 | 50 | B-1 | 50 | 120 | 70 | 5.0 | 2.0 | 120 | 120 | 12 | Present | Present | 51 |
| member 31 | | | | | | | | | | | | | | |
| Comparative | D-6 | 50 | E-1 | 50 | 15 | 70 | 5.0 | 2.0 | 120 | 120 | 14 | Absent | Present | 47 |
| photosensitive | | | | | | | | | | | | | | |
| member 1 | | | | | | | | | | | | | | |
| Comparative | D-6 | 50 | E-2 | 50 | 15 | 70 | 5.0 | 2.0 | 120 | 120 | 14 | Absent | Present | 48 |
| photosensitive | | | | | | | | | | | | | | |
| member 2 | | | | | | | | | | | | | | |
| Comparative | D-6 | 50 | E-3 | 50 | 15 | 70 | 5.0 | 2.0 | 120 | 120 | 14 | Absent | Present | 46 |
| photosensitive | | | | | | | | | | | | | | |
| member 3 | | | | | | | | | | | | | | |
| Comparative | D-3 | 50 | E-4 | 50 | 15 | 70 | 5.0 | 2.0 | 120 | 120 | 14 | Absent | Present | 44 |
| photosensitive | | | | | | | | | | | | | | |
| member 4 | | | | | | | | | | | | | | |
| Comparative | D-12 | 50 | E-1 | 50 | 15 | 70 | 5.0 | 2.0 | 120 | 120 | 14 | Absent | Present | 49 |
| photosensitive | | | | | | | | | | | | | | |
| member 5 | | | | | | | | | | | | | | |
| Comparative | D-12 | 50 | E-2 | 50 | 15 | 70 | 5.0 | 2.0 | 120 | 120 | 14 | Absent | Present | 49 |
| photosensitive | | | | | | | | | | | | | | |
| member 6 | | | | | | | | | | | | | | |
| Comparative | D-12 | 50 | E-3 | 50 | 15 | 70 | 5.0 | 2.0 | 120 | 120 | 14 | Absent | Present | 48 |
| photosensitive | | | | | | | | | | | | | | |
| member 7 | | | | | | | | | | | | | | |
| Comparative | D-7 | 50 | E-4 | 50 | 15 | 70 | 5.0 | 2.0 | 120 | 120 | 14 | Absent | Present | 46 |
| photosensitive | | | | | | | | | | | | | | |
| member 8 | | | | | | | | | | | | | | |
| Comparative | F-1 | 50 | G-1 | 50 | 15 | 70 | 5.0 | 2.0 | 120 | 120 | 14 | Present | Absent | 55 |
| photosensitive | | | | | | | | | | | | | | |
| member 9 | | | | | | | | | | | | | | |
| Comparative | F-2 | 50 | G-1 | 50 | 15 | 70 | 5.0 | 2.0 | 120 | 120 | 14 | Present | Absent | 55 |
| photosensitive | | | | | | | | | | | | | | |
| member 10 | | | | | | | | | | | | | | |
| Comparative | F-3 | 50 | G-1 | 50 | 15 | 70 | 5.0 | 2.0 | 120 | 120 | 14 | Present | Absent | 56 |
| photosensitive | | | | | | | | | | | | | | |
| member 11 | | | | | | | | | | | | | | |
| Comparative | F-1 | 50 | G-2 | 50 | 15 | 70 | 5.0 | 2.0 | 120 | 120 | 14 | Present | Absent | 54 |
| photosensitive | | | | | | | | | | | | | | |
| member 12 | | | | | | | | | | | | | | |

### Method of Producing [Photosensitive Member 32]

A charge-generating layer and a charge transport layer were formed on the support in the same manner as in Example 1. Next, the following materials were prepared.
compound represented by Formula (D-6) above as OCL Monomer 1 50 parts
compound represented by Formula (B-1) above as OCL Monomer 2 50 parts
1-hydroxycyclohexyl phenyl ketone as a polymerization initiator 5 parts

These were mixed with a mixed solvent of 360 parts of 2-propanol and 40 parts of tetrahydrofuran, followed by stirring. Thus, a coating solution for a protective layer was prepared.

This coating solution for a protective layer was applied onto the charge transport layer by immersion coating to form a coating, the resulting coating was dried at 50° C. for 6 minutes. Subsequently, under a nitrogen atmosphere, the coating was irradiated with ultraviolet light for 20 seconds using an electrodeless lamp, H valve (available from Heraeus K.K.) at a lamp intensity of 0.7 W/cm² while the support (body to be irradiate) was being rotated at a rate of 300 rpm. Subsequently, under a nitrogen atmosphere, the temperature of the coating was increased to 120° C. The oxygen concentration from the irradiation with ultraviolet light to the subsequent heat treatment was 15 ppm. Next, the coating was spontaneously cooled in the air until the temperature of the coating reached 25° C., and then was heat treated for 1 hour under a condition such that the temperature of the coating reached 120° C., thereby forming a protective layer having a thickness of 3.5 μm. Thus, Photosensitive member 32 was prepared.

Methods of producing [Photosensitive member 33] to [Photosensitive member 36] and [Comparative Photosensitive member 13] to [Comparative Photosensitive member 16]

In the method of producing [Photosensitive member 32], the materials for the protective layer, the number of parts thereof, and the conditions for irradiation of the protective layer with ultraviolet light were varied as shown in Table 2. Except for these, [Photosensitive member 33] to [Photosensitive member 36] and [Comparative Photosensitive member 13] to [Comparative Photosensitive member 16] were prepared in the same manner as in the method of producing [Photosensitive member 32].

TABLE 2

| | OCL | | OCL | | Oxygen | | Heating in | | | | | |
|---|---|---|---|---|---|---|---|---|---|---|---|---|
| | monomer 1 | | monomer 2 | | concen- | | low oxygen | Heating | Lamp | | | Elastic |
| Photosensitive | Mate- | | Mate- | | tration/ | Time for | concentration/ | in air/ | intensity | Urethane | (Meth)acrylic | deformation |
| member | rial | Parts | rial | Parts | ppm | irradiation/s | ° C. | ° C. | W/cm2 | structure | resin | rate |
| Photosensitive | D-6 | 50 | B-1 | 50 | 15 | 20 | 120 | 120 | 0.7 | Present | Present | 52 |
| member 32 | | | | | | | | | | | | |
| Photosensitive | D-6 | 50 | B-1 | 50 | 50 | 10 | 120 | 120 | 0.7 | Present | Present | 47 |
| member 33 | | | | | | | | | | | | |
| Photosensitive | D-6 | 50 | B-1 | 50 | 50 | 6 | 120 | 120 | 0.7 | Present | Present | 43 |
| member 34 | | | | | | | | | | | | |
| Photosensitive | D-6 | 50 | B-1 | 50 | 50 | 6 | 120 | 120 | 1.0 | Present | Present | 45 |
| member 35 | | | | | | | | | | | | |
| Photosensitive | D-6 | 50 | B-1 | 50 | 150 | 20 | 120 | 120 | 0.7 | Present | Present | 48 |
| member 36 | | | | | | | | | | | | |
| Comparative | D-6 | 50 | E-1 | 50 | 15 | 20 | 120 | 120 | 0.7 | Absent | Present | 47 |
| photosensitive | | | | | | | | | | | | |
| member 13 | | | | | | | | | | | | |
| Comparative | D-6 | 50 | E-2 | 50 | 15 | 20 | 120 | 120 | 0.7 | Absent | Present | 47 |
| photosensitive | | | | | | | | | | | | |
| member 14 | | | | | | | | | | | | |
| Comparative | F-1 | 50 | G-1 | 50 | 15 | 20 | 120 | 120 | 0.7 | Present | Absent | 53 |
| photosensitive | | | | | | | | | | | | |
| member 15 | | | | | | | | | | | | |
| Comparative | F-1 | 50 | G-2 | 50 | 15 | 20 | 120 | 120 | 0.7 | Present | Absent | 53 |
| photosensitive | | | | | | | | | | | | |
| member 16 | | | | | | | | | | | | |

Analysis of Photosensitive Member

### <Method of Measuring Elastic Deformation Rate>

The elastic deformation rate of the surface layer in the photosensitive member was measured using a Fischer durometer (trade name: H100VP-HCU, available from Fischer Instruments Co.) under a high temperature and high humidity (30° C./80% RH) environment (HH environment). As an indenter, a Vickers quadrangular pyramid diamond indenter having an angle between its facing surfaces of 136° was used. The indenter was forced into the surface of the target surface layer, a load to 2 mN was applied over 7 seconds, and was gradually reduced over 7 seconds until the load reached 0 mN. During this operation, the forced depth was continuously measured. From the results, the elastic deformation rate was determined.

### <Analysis of (Meth)Acrylic Resin Having Urethane Structure>

As described below, pyrolysis GCMS and FTIR were used in analysis of the presence/absence of the urethane structure in the surface layer in the photosensitive member and that of the presence/absence of the (meth)acrylic resin.

### <Pyrolysis GCMS>

The surface layer of the prepared photosensitive member was peeled off by scraping with a razor. The peeled surface layer was immersed in chloroform, and was ultrasonically irradiated with an ultrasonic apparatus for 1 hour. Subsequently, chloroform-insoluble components were taken out, followed by drying to give a residue. A TMAH methylating agent and the residue were mixed, and the mixture was analyzed on the following conditions for measurement. From the results of analysis, it was verified whether a urethane structure and a compound derived from a (meth)acrylic resin were detected, and the structure before pyrolysis was inferred.

### (Conditions for Measurement)

pyrolysis apparatus: JPS-700 (Japan Analytical Industry Co., Ltd.)
decomposition temperature: 590° C.
GC/MS apparatus: Focus GC/ISQ (Thermo Fisher)
column: HP-5MS length of 60 m, inner diameter of 0.25 mm, film thickness of 0.25 μm
temperature of inlet for injection: 200° C.
flow pressure: 100 kPa
split: 50 mL/min
MS ionization: EI
temperature for ion source: 200° C. Mass Range 45-650

### <FTIR>

In the surface layer of the prepared photosensitive member, the infrared spectrum from 600 cm⁻¹ to 4000 cm⁻¹ was measured by a Fourier transform infrared spectroscopic total internal reflectance method on the following conditions, and it was verified that the result was consistent with the structure inferred from the result of the pyrolysis GCMS above.

### (Conditions for Measurement)

apparatus: FT/IR-420 (available from JASCO Corporation)
apparatus attached: ATR apparatus
IRE (internal reflection element): Ge
angle of incidence: 45 degrees
the integrated number of rotations: 32

### <Production of Toner>

### <Preparation Example of Resin Particles Dispersion 1>

styrene 70.0 parts
butyl acrylate 28.7 parts
acrylic acid 1.3 parts
n-lauryl mercaptan 3.2 parts

The materials above were placed into a container, and were mixed with stirring. An aqueous solution of 1.5 parts of NEOGEN RK (available from Dai-ichi Kogyo Seiyaku Co., Ltd.) in 150.0 parts of deionized water was added to this solution, and was dispersed.

While the system was being slowly stirred for another 10 minutes, an aqueous solution of 0.3 parts of potassium persulfate in 10.0 parts of deionized water was added. After the system was purged with nitrogen, emulsion polymerization was performed at 70° C. for 6 hours. After the polymerization was ended, the reaction solution was cooled to room temperature, and deionized water was added to give Resin particles dispersion 1 having a solids content of 12.5% by mass and a glass transition temperature of 48° C. The particle size distribution of the resin particles contained in Resin particles dispersion 1 was measured with a particle size analyzer (available from HORIBA, Ltd., LA-920). The number average particle size of the resin particles was 0.2 μm. Coarse particles having a particle size of more than 1 μm were not observed.

### <Preparation Example of Resin Particles Dispersion 2>

styrene 78.0 parts
butyl acrylate 20.7 parts
acrylic acid 1.3 parts
n-lauryl mercaptan 3.2 parts

The materials above were placed into a container, and were mixed with stirring. An aqueous solution of 1.5 parts of NEOGEN RK (available from Dai-ichi Kogyo Seiyaku Co., Ltd.) in 150.0 parts of deionized water was added to this solution, and was dispersed.

While the system was being slowly stirred for another 10 minutes, an aqueous solution of 0.3 parts of potassium persulfate in 10.0 parts of deionized water was added. After the system was purged with nitrogen, emulsion polymerization was performed at 70° C. for 6 hours. After the polymerization was ended, the reaction solution was cooled to room temperature, and deionized water was added to give Resin particles dispersion 2 having a solids content of 12.5% by mass and a glass transition temperature of 60° C. The particle size distribution of the resin particles contained in Resin particles dispersion 2 was measured with a particle size analyzer (available from HORIBA, Ltd., LA-920). The number average particle size of the resin particles was 0.2 μm. Coarse particles having a particle size of more than 1 μm were not observed.

### <Preparation Example of Resin Particles Dispersion 3>

styrene 76.0 parts
butyl acrylate 22.7 parts
acrylic acid 1.3 parts
n-lauryl mercaptan 3.2 parts

The materials above were placed into a container, and were mixed with stirring. An aqueous solution of 1.5 parts of NEOGEN RK (available from Dai-ichi Kogyo Seiyaku Co., Ltd.) in 150.0 parts of deionized water was added to this solution, and was dispersed.

While the system was being slowly stirred for another 10 minutes, an aqueous solution of 0.3 parts of potassium persulfate in 10.0 parts of deionized water was added. After the system was purged with nitrogen, emulsion polymerization was performed at 70° C. for 6 hours. After the polymerization was ended, the reaction solution was cooled to room temperature, and deionized water was added to give Resin particles dispersion 3 having a solids content of 12.5% by mass and a glass transition temperature of 58° C. The particle size distribution of the resin particles contained in Resin particles dispersion 3 was measured with a particle size analyzer (available from HORIBA, Ltd., LA-920). The number average particle size of the resin particles was 0.2 μm. Coarse particles having a particle size of more than 1 μm were not observed.

### <Preparation Example of Mold Release Agent Dispersion 1>

100.0 Parts of behenyl behenate (melting point: 72.1° C.) and 15.0 parts of NEOGEN RK were mixed with 385.0 parts of deionized water, and were dispersed for about one hour using a wet jet mill JN100 (available from Jokoh Co., Ltd.) to give Mold release agent dispersion 1. The wax concentration in Mold release agent dispersion 1 was 20.0% by mass. The particle size distribution of particles of the mold release agent contained in Mold release agent dispersion 1 was measured using a particle size analyzer (available from HORIBA, Ltd., LA-920). The particles of the mold release agent contained had a number average particle size of 0.35 μm. Coarse particles having a particle size of more than 1 μm were not observed.

### <Preparation Example of Mold Release Agent Dispersion 2>

100.0 parts of hydrocarbon wax HNP-9 (available from Nippon Seiro Co., Ltd., melting point: 75.5° C.) and 15 parts of NEOGEN RK were mixed with 385.0 parts of deionized water, and were dispersed for about one hour using a wet jet mill JN100 (available from Jokoh Co., Ltd.) to give Mold release agent dispersion 2. The wax concentration of Mold release agent dispersion 2 was 20.0% by mass. The particle size distribution of particles of the mold release agent contained in Mold release agent dispersion 2 was measured using a particle size analyzer (available from HORIBA, Ltd., LA-920). The particles of the mold release agent contained had a number average particle size of 0.35 μm. Coarse particles having a particle size of more than 1 μm were not observed.

### <Preparation Example of Colorant Dispersion 1>

50.0 parts of copper phthalocyanine (Pigment Blue 15:3) as a colorant and 5.0 parts of NEOGEN RK were mixed with 200.0 parts of deionized water, and were dispersed for about one hour using a wet jet mill JN100 to give Colorant dispersion 1. Colorant dispersion 1 had a solids content of 20.0% by mass. The particle size distribution of the colorant particles contained in Colorant dispersion 1 was measured using a particle size analyzer (available from HORIBA, Ltd., LA-920). The colorant particles contained had a number average particle size of 0.20 μm. Coarse particles having a particle size of more than 1 μm were not observed.

Method of Producing [Toner Particles 1]
Resin particles dispersion 1: 265.0 parts
Mold release agent dispersion 1: 10.0 parts
Mold release agent dispersion 2: 8.0 parts
Colorant dispersion 1: 8.0 parts

In the step of forming cores of toner particles, the materials above were placed into a round flask made of stainless steel, and were mixed. Subsequently, these were dispersed for 10 minutes at 5000 r/min using a homogenizer (IKA Works GmbH & Co. KG: ULTRA-TURRAX T50). The inner temperature of the container was adjusted to 30° C. with stirring, and an aqueous solution of 1 mol/L sodium hydroxide was added to adjust the pH to 8.0.

An aqueous solution of 0.25 parts of aluminum chloride as coagulating agent dissolved in 10.0 parts of deionized water was added at 30° C. over 10 minutes under stirring. The solution was left to stand for 3 minutes, and heating was started. The solution was heated to 60° C. to generate aggregated particles (form cores). The volume-based median particle size of the resulting aggregated particles was checked using a “Coulter Counter Multisizer 3” (registered trademark, available from Beckman Coulter, Inc.) for convenience. At a point of time when the volume-based median particle size reached 7.0 μm, in the step of forming a shell, 15.0 parts of Resin particles dispersion 2 was further added and stirred for another one hour to form a shell.

Subsequently, an aqueous solution of 1 mol/L sodium hydroxide was added to adjust the pH to 9.0, followed by heating to 95° C. to spheronize the aggregated particles. After the average circularity reached 0.980, the temperature was lowered to cool the product to room temperature. Thus, Toner particle dispersion 1 was prepared.

Hydrochloric acid was added to Toner particle dispersion 1 prepared to adjust the pH to 1.5 or less, and the system was stirred for one hour, and then was left. The dispersion was subjected to solid liquid separation in a pressurized filter to give a toner cake. The toner cake was formed into a slurry again with deionized water to prepare a dispersion again. Thereafter, the dispersion was subjected to solid liquid separation through the filter above. The re-formation of the slurry and the solid liquid separation were repeated until the electric conductivity of the filtrate reached 5.0 μS/cm or less, followed by final solid liquid separation to give a toner cake. The resulting toner cake was dried, and was further classified using a classifier such that the volume-based median particle size was 7.0 μm. Thus, Toner particles 1 were obtained.

### Methods of Producing [Toner Particles 2] to [Toner Particles 9]

In the method of producing [Toner particles 1], the types of the coagulating agent and the number of parts thereof added were varied as shown in Table 3 below. Except for these, [Toner particles 2] to [Toner particles 9] were prepared in the same manner as in the method of producing [Toner particles 1].

TABLE 3

Coagulating agent

| | | Amount added |
|---|---|---|
| Toner particles | Type | (parts by mass) |
| Toner particles 1 | Aluminum chloride | 0.25 |
| Toner particles 2 | Magnesium chloride | 0.22 |
| Toner particles 3 | Calcium chloride | 0.48 |
| Toner particles 4 | Iron(III) chloride | 0.35 |
| Toner particles 5 | Aluminum chloride | 0.30 |
| Toner particles 6 | Aluminum chloride | 0.45 |
| Toner particles 7 | Aluminum chloride | 0.15 |
| Toner particles 8 | Aluminum chloride | 0.58 |
| Toner particles 9 | Aluminum chloride | 0.08 |

Method of Producing [Toner Particles 10]
Resin particles dispersion 3: 265.0 parts
Mold release agent dispersion 1: 10.0 parts
Mold release agent dispersion 2: 8.0 parts
Colorant dispersion 1: 8.0 parts

In the step of forming cores of toner particles, the materials above were placed into a round flask made of stainless steel, and were mixed. Subsequently, these were dispersed for 10 minutes at 5000 r/min using a homogenizer (IKA Works GmbH & Co. KG: ULTRA-TURRAX T50). The inner temperature of the container was adjusted to 30° C. with stirring, and an aqueous solution of 1 mol/L sodium hydroxide was added to adjust the pH to 8.0.

An aqueous solution of 0.25 parts of aluminum chloride as coagulating agent dissolved in 10.0 parts of deionized water was added over 10 minutes under stirring at 30° C. The solution was left to stand for 3 minutes, and heating was started. The solution was heated to 60° C. to generate aggregated particles (form cores). The volume-based median particle size of the resulting aggregated particles was checked using a “Coulter Counter Multisizer 3” (registered trademark, available from Beckman Coulter, Inc.) for convenience. At a point of time when the volume-based median particle size reached 7.0 μm, an aqueous solution of 1 mol/L sodium hydroxide was added to adjust the pH to 9.0, followed by heating to 95° C. to spheronize the aggregated particles. After the average circularity reached 0.980, the temperature was lowered to cool the product to room temperature. Thus, Toner particle dispersion 2 was prepared.

Hydrochloric acid was added to Toner particle dispersion 2 prepared to adjust the pH to 1.5 or less, and the system was stirred for one hour, and then was left. The dispersion was subjected to solid liquid separation through a pressurized filter to give a toner cake. The toner cake was formed into a slurry again with deionized water to prepare a dispersion again. Thereafter, the dispersion was subjected to solid liquid separation through the filter above. The re-formation of the slurry and the solid liquid separation were repeated until the electric conductivity of the filtrate reached 5.0 μS/cm or less, followed by final solid liquid separation to give a toner cake. The resulting toner cake was dried, and was further classified using a classifier such that the volume-based median particle size was 7.0 μm. Thus, Toner particles 10 were obtained.

### Method of Producing [Hydrotalcite Particles 1]

A mixed aqueous solution (solution A) of 1.03 mol/L magnesium chloride and 0.239 mol/L and aluminum sulfate, an aqueous solution of 0.753 mol/L sodium carbonate (solution B), and an aqueous solution of 3.39 mol/L sodium hydroxide (solution C) were prepared.

Next, using a constant volume pump, the solution A, the solution B, and the solution C were poured into a reaction tank at flow rates such that the volume ratio of the solution A to the solution B was 4.5:1, and the relation was performed at a reaction temperature of 40° C. while the pH of the reaction solution was kept in the range of 9.3 to 9.6 with the solution C. Thus, a precipitate was formed. After filtration and washing, the precipitate was emulsified again with deionized water to give a hydrotalcite slurry as a raw material. The resulting hydrotalcite slurry contained 5.6% by mass of hydrotalcite. The hydrotalcite slurry was dried in vacuum at 40° C. overnight. NaF was dissolved in deionized water such that the concentration was 100 mg/L, and the pH of the solution was adjusted to 7.0 with 1 mol/L HCl or 1 mol/L NaOH. Dry hydrotalcite was added to the resulting solution such that the content was 0.1% (w/v %). The solution was stirred with a magnetic stirrer for 48 hours at a constant rate not to cause sedimentation. Subsequently, the solution was filtered through a membrane filter having a pore diameter of 0.5 μm, and the product was washed with deionized water. The resulting hydrotalcite was dried in vacuum at 40° C. overnight, and then was disintegrated.

Methods of Producing [Hydrotalcite Particles 2] to [Hydrotalcite Particles 13]

In the method of producing [Hydrotalcite particles 1], volume ratio of the solution A to the solution B and the concentration of the NaF aqueous solution were appropriately adjusted. Except for these, [Hydrotalcite particles 2] to [Hydrotalcite particles 13] were prepared in the same method as in the method of producing [Hydrotalcite particles 1].

Method of Producing [Hydrotalcite Particles 14]

In the method of producing [Hydrotalcite particles 1], deionized water was used instead of the NaF aqueous solution. Except for this, [Hydrotalcite particles 14] were prepared in the same manner as in the method of producing [Hydrotalcite particles 1].

Method of Producing [Hydrotalcite Particles 15]

A mixed aqueous solution (solution A) of 1.03 mol/L magnesium chloride and 0.239 mol/L aluminum sulfate, an aqueous solution of 0.753 mol/L sodium carbonate (solution B), and an aqueous solution of 3.39 mol/L sodium hydroxide (solution C) were prepared.

Next, using a constant volume pump, the solution A, the solution B, and the solution C were poured into a reaction tank at flow rates such that the volume ratio of the solution A to the solution B was 4.5:1, and the reaction was performed at a reaction temperature of 40° C. while the pH of the reaction solution was kept in the range of 9.3 to 9.6 with the solution C. Thus, a precipitate was formed. After filtration and washing, the precipitate was emulsified again with deionized water to give a hydrotalcite slurry as a raw material. The resulting hydrotalcite slurry contained 5.6% by mass of hydrotalcite. The hydrotalcite slurry was kept at 95° C., and 5 parts by mass of fluorosilicone oil was added relative to 95 parts by mass of the solids content to perform a surface treatment. In the next step, the product was subjected to filtration and washing with water, was dried at 100° C. for 24 hours, and was disintegrated with an atomizer mill (available from DALTON CORPORATION) to give Hydrotalcite particles 15.

Method of Producing [Toner 1]

0.3 parts of Hydrotalcite particles 1 and 1.5 parts of silica particles 1 (RX200: primary average particle size of 12 nm, HMDS treatment, available from Nippon Aerosil Co., Ltd.) were externally added relative to 100.0 parts of Toner particles 1 prepared above with FM10C (available from NIPPON COKE & ENGINEERING CO., LTD.) and mixed. For the conditions for external addition, the lower blade was an A0 blade, the interval therefrom to the wall of a deflector was set to 20 mm, the amount of toner particles charged was 2.0 kg, the number of rotations was 66.6 s⁻¹, and external addition was performed for a time for external addition of 10 minutes with cooling water at a temperature of 20° C. and a flow rate of 10 L/min.

Subsequently, the product was sieved through a mesh having an opening of 200 μm to give Toner 1.

Methods of Producing [Toner 2] to [Toner 25] and [Comparative Toner 1]

In the method of producing [Toner 1], the type of toner particles, the type of hydrotalcite particles, and the amount thereof added were varied as shown in Table 4 below. Except for these, [Toner 2] to [Toner 25] and [Comparative Toner 1] were prepared in the same manner as in the method of producing [Toner 1].

Method of Producing [Comparative Toner 2]

In the method of producing [Toner 1], Hydrotalcite particles 1 were replaced by polytetrafluoroethylene fine particles “Fluoro A” (available from Shamrock Technologies, Inc., average particle size of primary particles: 0.3 μm). Except for this, [Comparative Toner 2] was prepared in the same manner as in the method of producing [Toner 1].

Method of Producing [Comparative Toner 3]

In the method of producing [Toner 1], Hydrotalcite particles 1 were replaced by fluorine-containing alumina particles. Except for that, [Comparative Toner 3] was prepared in the same manner as in the method of producing [Toner 1].

TABLE 4

| | Toner particles | | Hydrotalcite particles | | Silica particles 1 |
|---|---|---|---|---|---|
| | | Amount added | | Amount added | Amount added |
| Toner | Type | (parts by mass) | Type | (parts by mass) | (parts by mass) |
| Toner 1 | Toner particles 1 | 100 | Hydrotalcite particles 1 | 0.3 | 1.5 |
| Toner 2 | Toner particles 10 | 100 | Hydrotalcite particles 2 | 0.3 | 1.5 |
| Toner 3 | Toner particles 10 | 100 | Hydrotalcite particles 3 | 0.3 | 1.5 |
| Toner 4 | Toner particles 10 | 100 | Hydrotalcite particles 4 | 0.3 | 1.5 |
| Toner 5 | Toner particles 10 | 100 | Hydrotalcite particles 5 | 0.3 | 1.5 |
| Toner 6 | Toner particles 10 | 100 | Hydrotalcite particles 6 | 0.3 | 1.5 |
| Toner 7 | Toner particles 10 | 100 | Hydrotalcite particles 7 | 0.3 | 1.5 |
| Toner 8 | Toner particles 10 | 100 | Hydrotalcite particles 8 | 0.3 | 1.5 |
| Toner 9 | Toner particles 10 | 100 | Hydrotalcite particles 9 | 0.5 | 1.5 |
| Toner 10 | Toner particles 10 | 100 | Hydrotalcite particles 10 | 0.1 | 1.5 |
| Toner 11 | Toner particles 10 | 100 | Hydrotalcite particles 11 | 0.05 | 1.5 |
| Toner 12 | Toner particles 10 | 100 | Hydrotalcite particles 12 | 0.5 | 1.5 |
| Toner 13 | Toner particles 10 | 100 | Hydrotalcite particles 13 | 0.3 | 1.5 |
| Toner 14 | Toner particles 10 | 100 | Hydrotalcite particles 15 | 0.3 | 1.5 |
| Toner 15 | Toner particles 2 | 100 | Hydrotalcite particles 1 | 0.3 | 1.5 |
| Toner 16 | Toner particles 3 | 100 | Hydrotalcite particles 1 | 0.3 | 1.5 |
| Toner 17 | Toner particles 4 | 100 | Hydrotalcite particles 1 | 0.3 | 1.5 |
| Toner 18 | Toner particles 5 | 100 | Hydrotalcite particles 1 | 0.3 | 1.5 |
| Toner 19 | Toner particles 6 | 100 | Hydrotalcite particles 1 | 0.3 | 1.5 |
| Toner 20 | Toner particles 7 | 100 | Hydrotalcite particles 1 | 0.3 | 1.5 |
| Toner 21 | Toner particles 8 | 100 | Hydrotalcite particles 1 | 0.3 | 1.5 |
| Toner 22 | Toner particles 9 | 100 | Hydrotalcite particles 1 | 0.3 | 1.5 |
| Toner 23 | Toner particles 10 | 100 | Hydrotalcite particles 1 | 0.3 | 1.5 |
| Toner 24 | Toner particles 10 | 100 | Hydrotalcite particles 9 | 0.15 | 1.5 |
| Toner 25 | Toner particles 10 | 100 | Hydrotalcite particles 9 | 0.2 | 1.5 |
| Comparative | Toner particles 1 | 100 | Hydrotalcite particles 14 | 0.3 | 1.5 |
| toner 1 | | | | | |
| Comparative | Toner particles 1 | 100 | PTFE particles | 0.3 | 1.5 |
| toner 2 | | | | | |
| Comparative | Toner particles 1 | 100 | Fluorine-containing alumina particles | 0.3 | 1.5 |
| toner 3 | | | | | |

Toners 1 to 25 and Comparative Toners 1 to 3 prepared were analyzed about whether or not hydrotalcite particles contained fluorine, magnesium, and aluminum and whether or not fluorine, when contained in hydrotalcite particles, was present inside the hydrotalcite particles. The content q of the hydrotalcite particles in the toner was measured. The results are shown in Table 5 below.

TABLE 5

| | Hydrotalcite particles | | | | |
|---|---|---|---|---|---|
| | | Presence/ | | | |
| | | absence of | | | |
| | Presence/ | fluorine | Presence/ | Presence/ | |
| | absence of | inside cross- | absence of | absence of | q |
| Toner | fluorine | section | magnesium | aluminum | [%] |
| Toner 1 | Present | Present | Present | Present | 0.295 |
| Toner 2 | Present | Present | Present | Present | 0.295 |
| Toner 3 | Present | Present | Present | Present | 0.295 |
| Toner 4 | Present | Present | Present | Present | 0.295 |
| Toner 5 | Present | Present | Present | Present | 0.295 |
| Toner 6 | Present | Present | Present | Present | 0.295 |
| Toner 7 | Present | Present | Present | Present | 0.295 |
| Toner 8 | Present | Present | Present | Present | 0.295 |
| Toner 9 | Present | Present | Present | Present | 0.490 |
| Toner 10 | Present | Present | Present | Present | 0.098 |
| Toner 11 | Present | Present | Present | Present | 0.049 |
| Toner 12 | Present | Present | Present | Present | 0.490 |
| Toner 13 | Present | Present | Present | Present | 0.295 |
| Toner 14 | Present | Absent | Present | Present | 0.295 |
| Toner 15 | Present | Present | Present | Present | 0.295 |
| Toner 16 | Present | Present | Present | Present | 0.295 |
| Toner 17 | Present | Present | Present | Present | 0.295 |
| Toner 18 | Present | Present | Present | Present | 0.295 |
| Toner 19 | Present | Present | Present | Present | 0.295 |
| Toner 20 | Present | Present | Present | Present | 0.295 |
| Toner 21 | Present | Present | Present | Present | 0.295 |
| Toner 22 | Present | Present | Present | Present | 0.295 |
| Toner 23 | Present | Present | Present | Present | 0.295 |
| Toner 24 | Present | Present | Present | Present | 0.148 |
| Toner 25 | Present | Present | Present | Present | 0.197 |
| Comparative | Absent | Absent | Present | Present | 0.295 |
| toner 1 | | | | | |
| Comparative | — | — | — | — | — |
| toner 2 | | | | | |
| Comparative | — | — | — | — | — |
| toner 3 | | | | | |

Analysis of Toner

### <Method of Analyzing Elements of Hydrotalcite Particles>

The analyses of the elements of the hydrotalcite particles were performed using EDS mapping measurement of the toner using a scanning transmission electron microscope (TEM). In the EDS mapping measurement, picture cells (pixels) in an analyzed area each have spectrum data, and EDS mapping can be measured with high sensitivity by using a silicon drift detector having a large element area for detection. By statistic analysis of spectrum data of each of the pixels obtained from the EDS mapping measurement, main component mapping of extracted pixels having similar spectra can be obtained, enabling mapping in which the components are specified.

A sample for observation is prepared by the following procedure.

0.5 g of a toner is weighed, and is left to stand in a cylindrical mold having a diameter of 8 mm under a load of 40 kN for 2 minutes in a Newton press. Thus, a cylindrical toner pellet having a diameter of 8 mm and a thickness of about 1 mm was prepared. A slice having a thickness of 200 nm is prepared from the toner pellet using an ultramicrotome (Leica, FC7).

In STEM-EDS analysis, measurement was performed with the apparatuses and conditions below.

Measurement apparatus 1 used: scanning transmission electron microscope; available from JEOL, Ltd., JEM-2800
Measurement apparatus 2 used: EDS detector; available from JEOL, Ltd., JED-2300T Dry SD100 GV detector (element area for detection: 100 mm²)
Measurement apparatus 3 used: EDS analyzer; available from Thermo Fisher Scientific Inc., NORAN System 7

### (Conditions for STEM-EDS)

STEM accelerating voltage: 200 kV
magnification: 20,000×
probe size: 1 nm

STEM image size: 1024×1024 pixels (EDS element mapping image at the same position is captured)

EDS mapping size: 256×256 pixels, Dwell Time: 30 ρs, the number of integrations: 100 frames

The ratio of the polyvalent metal element in the toner particles and the ratios of the elements in the hydrotalcite particles based on multivariate analysis were determined through calculation below.

Hereinafter, the filter fitting analysis according to the present disclosure will be described.

An EDS mapping was obtained by the STEM-EDS analyzer. In the next step, the collected spectrum mapping data was subjected to multivariate analysis using a COMPASS (PCA) mode in measurement commands of NORAN System 7 described above, thereby extracting a main component mapping image.

At this time, the setting values were set as follows.
kernel size: 3×3
quantitating mapping setting: high (slow)
filter fitting type: highly precise (slow)

At the same time, the area ratios of the extracted main components in the EDS measurement field are calculated by this operation. The EDS spectra of the main components obtained were subjected to quantitative analysis by the Cliff-Lorimer method.

The toner particles and the hydrotalcite particles are distinguished based on the results of quantitative analysis of the obtained STEM-EDS main component mapping. From the particle size, the shape, the content of a polyvalent metal such as aluminum or magnesium, and from the ratio of their contents, the particles can be identified as hydrotalcite particles.

When fluorine is present in the hydrotalcite particles, the particles can be determined as hydrotalcite particles containing fluorine by the following method.

(Method of Analyzing Fluorine Contained in Hydrotalcite Particles)

Based on the mapping data obtained by STEM-EDS analysis in the above-mentioned method, fluorine contained in the hydrotalcite particles is analyzed.

If the peak intensity of fluorine is present 1.5 times or higher than the background intensity in the EDS spectrum obtained from the main component mapping image of the particles extracted by COMPASS, it is determined that fluorine is contained in the particles.

<Method of Analyzing Fluorine Inside Hydrotalcite Particles>

Based on the mapping data obtained by STEM-EDS analysis in the above-mentioned method, fluorine inside the hydrotalcite particles is analyzed. Specifically, the surfaces of the particles are subjected to EDS line analysis in the normal direction to analyze fluorine present inside the particles.

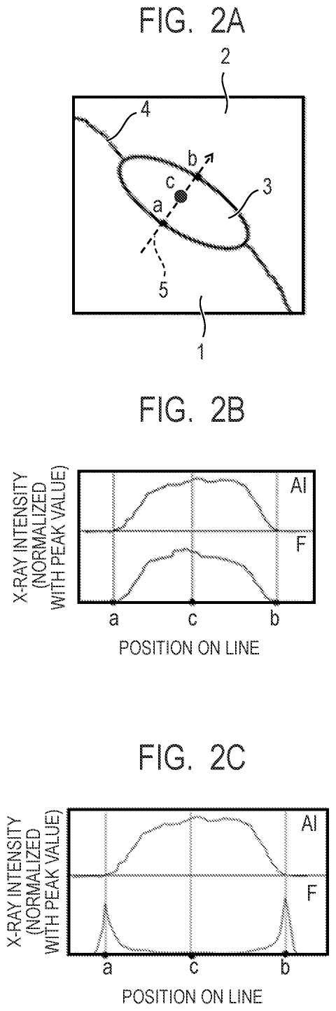

FIG. 2A illustrates a schematic view of line analysis. The outer periphery of a hydrotalcite particle 3 adjacent to a toner particle 1 and a toner particle 2 is subjected to line analysis in a normal direction, that is, in the direction of 5. A boundary 4 between the toner particles is shown.

In the captured STEM image, a region where the particles are present was selected with a rectangle selection tool, and was subjected to line analysis on the following conditions.

### (Conditions for Line Analysis)

STEM magnification: 800,000×
line length: 200 nm
line width: 30 nm
the number of line divisions: 100 points (intensity was measured every 2 nm) or

When the element peak intensity of fluorine is present 1.5 times or higher than the background intensity in the EDS spectrum of the hydrotalcite particle and the element peak intensities of fluorine in two ends (point a and point b in FIG. 2A) of a hydrotalcite particle in line analysis do not exceed the peak intensity 3.0 times the peak intensity of a point c, it is determined that the element is contained inside the hydrotalcite particle. The point c is the central point of the line segment ab (namely, the central point of the two ends).

FIGS. 2B and 2C each show an example of the X-ray intensity of fluorine obtained in the line analysis. If the hydrotalcite particle contains fluorine, the graph of the X-ray intensity standardized with the peak intensity shows the shape as in FIG. 2B. If the hydrotalcite particle contains fluorine derived from the surface treatment agent, the graph of the X-ray intensity standardized with the peak intensity has peaks near the points a and b in the two ends in the graph of fluorine as in FIG. 2C. By verifying the X-ray intensity derived from fluorine in the line analysis, it can be verified that fluorine is contained inside the hydrotalcite particles.

### <Method of Measuring Proportion q of Hydrotalcite Particles to Toner>

Using fluorescence X-ray analysis, the proportion q of the hydrotalcite particles to the toner can be quantitated based on the calibration curve created from standard samples. The elements are measured with fluorescence X-ray according to JIS K 0119-1969, which is specifically performed as follows.

The measurement apparatus to be used is a wavelength dispersive X-ray fluorescence analyzer “Axios” (available from PANalytical B.V Ltd.) in addition to dedicated software “SuperQ ver.4.0F” (available from PANalytical B.V. Ltd.) for setting measurement conditions and analyzing data from measurement. Rh is used for the anode of an X-ray tube, the measurement atmosphere is in vacuum, the measurement diameter (collimator mask diameter) is 27 mm, and the measurement time is 10 seconds. A proportional counter (PC) is used for detection when a light element is measured, and a scintillation counter (SC) is used for detection when a heavy element is measured.

A sample for measurement to be used is a pellet prepared by placing about 4 g of a toner into an aluminum ring of a dedicated press, smoothing the toner to be flat, and applying a pressure of 20 MPa for 60 seconds using a tablet molding press machine to form the toner into a thickness of about 2 mm and a diameter of about 39 mm. The tablet molding press machine used was “BRE-32” available from Maekawa Testing Machine Mfg. Co., LTD.

The measurement is performed on the conditions above, the element is identified based on the obtained peak position of the X-ray, and the concentration is calculated from the counting rate (unit: cps), which is the number of X-ray photons per unit time.

A standard product of hydrotalcite particles separately prepared is added in an amount of 0.10 parts by mass relative to 100 parts by mass of the toner not containing the hydrotalcite particles, and is sufficiently mixed with a coffee mill. Similarly, the hydrotalcite particles are mixed with the toner in amounts of 0.20 parts by mass and 0.50 parts by mass, respectively, and the resulting mixtures are used as samples for calibration curves.

Each of the samples is measured for the counting rate (unit: cps) derived from the metal element in hydrotalcite. At this time, the accelerating voltage and the current value of the X-ray generator are 24 kV and 100 mA, respectively. The obtained counting rate of the X-ray is plotted against the ordinate, the amount of the hydrotalcite particles added in each sample for the calibration curve is plotted against the abscissa, and the calibration curve of a primary function is obtained.

Next, the toner to be analyzed is formed into a pellet using a tablet molding press machine as described above, and the counting rate derived from the metal element in the hydrotalcite is measured. From the calibration curves, the proportion q of the hydrotalcite particles to the toner is determined.

### <Production of Charging Member (Charging Roller)>

### Method of Producing [Charging Roller 1]

### <1. Preparation of Rubber Mixture for Forming Electroconductive Elastic Layer>

The materials of the types shown in Table 6 were mixed in the amounts compounded shown in Table 6 with a 6-L pressurized kneader (product name: TD6-15MDX, available from Toshin Co., Ltd.) to prepare an unvulcanized rubber mixture. The mixing was performed at a fill rate of 70 vol % with the number of rotations of the blade of 30 rpm for 16 minutes.

TABLE 6

| | | Amount compounded |
|---|---|---|
| | Materials (trade names, manufactures) | (parts by mass) |
| Raw material rubber | Hydrin rubber (Epichlomer-CG102, available from OSAKA SODA CO., | 50 |
| | LTD.) | |
| Raw material rubber | Acrylic nitrile rubber (N230SV, available from JSR Corporation) | 50 |
| Electroconductive agent | Carbon black (TOKABLACK #7360, available from Tokai Carbon Co., | 50 |
| | Ltd.) | |
| Filler | Calcium carbonate (trade name, NANOX #30, available from Maruo | 45 |
| | Calcium Co., Ltd.) | |
| Plasticizer | Aliphatic polyester plasticizer (trade name: POLYCIZER P202, | 5 |
| | available from DIC Corporation) | |

Furthermore, the unvulcanized rubber mixture prepared above was mixed with the materials of the types shown in Table 7 below in the amounts compounded shown in Table 7 below with an open roll mill to prepare a rubber mixture for forming an electroconductive elastic layer. The mixer used was an open roll mill having a roll diameter of 12 inches. The number of rotations of the forward roll was 10 rpm, the number of rotations of the backward roll was 8 rpm, and left-right turning was performed 20 times in total with a roll gap of 2 mm, followed by tight milling 10 times with a roll gap of 1.0 mm.

TABLE 7

| | | Amount compounded |
|---|---|---|
| | Materials (trade names, manufactures) | (parts by mass) |
| Raw material rubber | Unvulcanized rubber mixture | 100 |
| Vulcanizing aid | Zinc stearate (trade name: Zinc Stearate, available from NOF | 1.5 |
| | CORPORATION) | |
| Vulcanizing aid | Zinc stearate (trade name: Stearic Acid Tsubaki, available from NOF | 2 |
| | CORPORATION) | |
| Vulcanizing agent | Sulfur (trade name: SULFAX PMC, available from Tsurumi Chemical | 3 |
| | Industry Co., ltd.) | |

### <2. Formation of Electroconductive Elastic Layer>

A rod having a total length of 252 mm and an outer diameter of 6 mm and having a free cutting steel surface subjected to electroless nickel plating was prepared. Next, using a roll coater, “METALOC U-20” (trade name, available from Toyokagaku Kenkyusho, Co., Ltd.) as an adhesive was applied to a circumferential region of the rod excluding regions of 11 mm from both ends, the circumferential region having a length of 230 mm. In Examples, the rod to which the adhesive was applied was used as an electroconductive support.

Next, a die having an inner diameter of 10.0 mm was attached to the distal end of a crosshead extruder having a feeding mechanism of the electroconductive support, and a discharging mechanism of the unvulcanized rubber roll, the temperatures of the extruder and the crosshead were controlled to 100° C., and the transportation rate of the electroconductive support was controlled to 60 mm/sec. Under this condition, the rubber mixture for forming an electroconductive elastic layer was fed from the extruder to coat the outer circumferential portion of the electroconductive support with the rubber mixture for forming an electroconductive elastic layer inside the crosshead. Thus, an unvulcanized rubber roll was prepared.

Next, the unvulcanized rubber roll was placed into a hot air vulcanization furnace at 170° C., and was heated for 60 minutes to vulcanize the layer of the unvulcanized rubber composition. Thus, a roll having an electroconductive resin layer formed on the outer circumferential surface of the electroconductive support was prepared. Subsequently, both ends of the electroconductive resin layer were cut off at positions of 12 mm from these ends to adjust the length of the electroconductive resin layer in the longitudinal direction to 228 mm.

Finally, the surface of the electroconductive resin layer was polished with a rotary grinding wheel. Thereby, Charging roller A with an electroconductive layer was prepared, Charging roller A having a diameter of 8.5 mm at a position of 90 mm from the central portion to each end and a central portion diameter of 8.6 mm.

### <3. Formation of Electroconductive Surface Layer>

Furthermore, an electroconductive surface layer was formed on Charging roller A with an electroconductive layer prepared above, as described below.

First, methyl isobutyl ketone was added to a caprolactone-modified acrylic polyol solution to adjust the solids content to 10% by mass. The materials shown in Table 8 below were mixed with 1000 parts by mass of the acrylic polyol solution (solids content: 100 parts by mass) to prepare a mixed solution. At this time, “NCO/OH=1.0” in the mixture of the block HDI and the block IPDI.

TABLE 8

| | | Amount compounded |
|---|---|---|
| | Materials (trade names, manufactures) | (parts by mass) |
| Main agent | Caprolactone-modified acrylic polyol solution | 100 |
| | (trade name: Placcel DC2016, available from DAICEL CHEMICAL | |
| | INDUSTRIES, LTD.) | |
| Curing agent | 7:3 mixture of HDI “Duranate TPA-B80E” (trade name, available from | 80.14 |
| | Asahi Kasei Corporation) and IPDI “VESTANAT B1370” (trade name, | |
| | available from Degussa-Huels AG) | |
| Electroconductive agent | Carbon black (trade name: #52, available from Mitsubishi Chemical | 20 |
| | Corporation) | |
| Additive | Modified dimethyl silicone oil | 0.1 |
| | (trade name: SH28PA, available from Dow Corning Toray Silicone Co., | |
| | Ltd.) | |

In the next step, 210 g of the mixed solution and 200 g of glass beads having an average particle size of 0.8 mm as a medium were mixed in a 450-mL glass bottle, followed by predispersion for 24 hours using a paint shaker dispersing machine.

Furthermore, 30 parts by mass (relative to 100 parts by mass of caprolactone-modified acrylic polyol) of polyurethane particles (trade name: Dynamic Beads UCN-5090: available from Dainichiseika Color & Chemicals Mfg. Co., Ltd.) having an average particle size of 9.0 μm was added to the glass bottle containing a coating material after the dispersion was completed, followed by dispersion again for 10 minutes with the paint shaker to prepare a coating material for forming a surface layer.

Charging roller A with an electroconductive layer was immersed in the coating material for forming a surface layer while the longitudinal direction thereof was aligned with the vertical direction, and was coated by dipping. The immersion time for dipping coating was 9 seconds, and the pulling rate was changed from an initial rate of 20 mm/sec to a final rate of 2 mm/sec, during which the rate was linearly changed against the time. The coated product was air dried at normal temperature for 30 minutes, then dried for one hour in a hot air circulating dryer set at 90° C., and further dried for one hour in a hot air circulating dryer set to 160° C. to produce Charging roller 1 according to the present disclosure. [Charging roller 1] had a ten-point average surface roughness of 12.4 μm.

Method of Producing [Charging Roller 2]

In the method of producing [Charging roller 1], the electroconductive roughening particles were changed to cross-linked polymethyl methacrylate resin particles (trade name: MBX-30, TECHPOLYMER) having an average particle size of 30 μm. Except for this, [Charging roller 2] was produced in the same manner as in the method of producing [Charging roller 1]. [Charging roller 2] had a ten-point average roughness of 28.5 μm.

Analysis of Charging Roller

### <Method of Measuring Ten-Point Average Surface Roughness>

According to the standard specified in JIS B 0601-1994 Surface Roughness, measurement was performed using a surface roughness meter (trade name: SE-3500, available from Kosaka Laboratory Ltd.).

Measurement target positions were selected as follows: The rubber portion of the charging roller was divided into four in the longitudinal direction and four in the circumferential direction to form 16 regions. In each of the 16 regions, 16 positions were selected at random and measured for the surface roughness. From these measured surface roughnesses, the arithmetic average was determined. For the conditions for measurement, the cutoff value was 0.8 mm, and the length for evaluation was 8 mm.

[Evaluations]

### [Examples 1 to 75 and Comparative Examples 1 to 23]

The transfer properties (transfer residual toner concentration) were evaluated using a modified machine of a laser beam printer LBP7700C commercially available from Canon Inc. As the modification, the body of the evaluation machine and software were changed such that the rotational speed of the developing roller was 360 mm/sec.

A prepared toner was charged into the toner cartridge of LBP7700C, and a prepared photosensitive member and a prepared charging roller were attached thereto. The toner cartridge was left to stand under a high temperature and high humidity (30° C./80% RH) environment (HH environment) for 24 hours. The toner cartridge after left to stand under the environment for 24 hours was attached to the modified machine of the laser beam printer LBP7700C commercially available from Canon Inc.

In the evaluation of the transfer properties, under a HH environment, an image having a coverage rate of 5.0% was printed on the central portion of an A4 sheet with a margin of 50 mm on the left and right sides in the traverse direction of the sheet until 10000 sheets were printed out, and evaluation was performed after 10000 sheets were output. During the evaluation of the transfer properties, a solid image was output, and a transfer residual toner on the photosensitive member when the solid image was formed was removed by taping up with a transparent polyester adhesive tape. The detached adhesive tape was applied to a sheet of paper, and the concentration of a sheet having only an adhesive tape applied thereto was subtracted from that of the sheet having the detached adhesive tape applied thereto to calculate the difference in concentration. The concentration was measured at five places on the photosensitive member when the solid image was formed, and the average thereof was determined. From the difference in concentration, the transfer properties were determined as follows.

The concentration was measured with an X-Rite color reflection densitometer (available from X-Rite K.K., X-Rite 500 Series). In the criteria for evaluation, the results having C or higher were determined as favorable.

### (Criteria for Evaluation)

A: a difference in concentration of less than 0.030
B: a difference in concentration of 0.030 or more and less than 0.050
C: a difference in concentration of 0.050 or more and less than 0.100
D: a difference in concentration of 0.100 or more

The results of evaluation are shown in Tables 9 and 10 below.

TABLE 9

| | | | | | Evaluations of transfer | |
|---|---|---|---|---|---|---|
| | | | | | properties | |
| | | | | | After 10,000 sheets were | |
| | | | | | printed | |
| | | | | | Transfer residue | |
| Example | Photosensitive member | Toner | Charging member | η/q | concentration | Rank |
| Example | Photosensitive member | Toner | Charging member | 183.2 | 0.037 | B |
| 1 | 1 | 14 | 2 | | | |
| Example | Photosensitive member | Toner | Charging member | 176.5 | 0.039 | B |
| 2 | 2 | 14 | 2 | | | |
| Example | Photosensitive member | Toner | Charging member | 176.5 | 0.033 | B |
| 3 | 3 | 14 | 2 | | | |
| Example | Photosensitive member | Toner | Charging member | 166.3 | 0.045 | B |
| 4 | 4 | 14 | 2 | | | |
| Example | Photosensitive member | Toner | Charging member | 156.1 | 0.036 | B |
| 5 | 5 | 14 | 2 | | | |
| Example | Photosensitive member | Toner | Charging member | 149.3 | 0.053 | C |
| 6 | 6 | 14 | 2 | | | |
| Example | Photosensitive member | Toner | Charging member | 183.2 | 0.033 | B |
| 7 | 7 | 14 | 2 | | | |
| Example | Photosensitive member | Toner | Charging member | 179.8 | 0.046 | B |
| 8 | 8 | 14 | 2 | | | |
| Example | Photosensitive member | Toner | Charging member | 166.3 | 0.035 | B |
| 9 | 9 | 14 | 2 | | | |
| Example | Photosensitive member | Toner | Charging member | 166.3 | 0.037 | B |
| 10 | 10 | 14 | 2 | | | |
| Example | Photosensitive member | Toner | Charging member | 166.3 | 0.038 | B |
| 11 | 11 | 14 | 2 | | | |
| Example | Photosensitive member | Toner | Charging member | 166.3 | 0.039 | B |
| 12 | 12 | 14 | 2 | | | |
| Example | Photosensitive member | Toner | Charging member | 152.7 | 0.043 | B |
| 13 | 13 | 14 | 2 | | | |
| Example | Photosensitive member | Toner | Charging member | 149.3 | 0.069 | C |
| 14 | 14 | 14 | 2 | | | |
| Example | Photosensitive member | Toner | Charging member | 139.1 | 0.090 | C |
| 15 | 15 | 14 | 2 | | | |
| Example | Photosensitive member | Toner | Charging member | 159.5 | 0.035 | B |
| 16 | 16 | 14 | 2 | | | |
| Example | Photosensitive member | Toner | Charging member | 152.7 | 0.036 | B |
| 17 | 17 | 14 | 2 | | | |
| Example | Photosensitive member | Toner | Charging member | 173.1 | 0.045 | B |
| 18 | 18 | 14 | 2 | | | |
| Example | Photosensitive member | Toner | Charging member | 176.5 | 0.032 | B |
| 19 | 19 | 14 | 2 | | | |
| Example | Photosensitive member | Toner | Charging member | 183.2 | 0.041 | B |
| 20 | 20 | 14 | 2 | | | |
| Example | Photosensitive member | Toner | Charging member | 162.9 | 0.038 | B |
| 21 | 21 | 14 | 2 | | | |
| Example | Photosensitive member | Toner | Charging member | 152.7 | 0.039 | B |
| 22 | 22 | 14 | 2 | | | |
| Example | Photosensitive member | Toner | Charging member | 145.9 | 0.063 | C |
| 23 | 23 | 14 | 2 | | | |
| Example | Photosensitive member | Toner | Charging member | 176.5 | 0.034 | B |
| 24 | 24 | 14 | 2 | | | |
| Example | Photosensitive member | Toner | Charging member | 183.2 | 0.044 | B |
| 25 | 25 | 14 | 2 | | | |
| Example | Photosensitive member | Toner | Charging member | 183.2 | 0.046 | B |
| 26 | 26 | 14 | 2 | | | |
| Example | Photosensitive member | Toner | Charging member | 183.2 | 0.044 | B |
| 27 | 27 | 14 | 2 | | | |
| Example | Photosensitive member | Toner | Charging member | 156.1 | 0.035 | B |
| 28 | 28 | 14 | 2 | | | |
| Example | Photosensitive member | Toner | Charging member | 145.9 | 0.082 | C |
| 29 | 29 | 14 | 2 | | | |
| Example | Photosensitive member | Toner | Charging member | 179.8 | 0.034 | B |
| 30 | 30 | 14 | 2 | | | |
| Example | Photosensitive member | Toner | Charging member | 173.1 | 0.032 | B |
| 31 | 31 | 14 | 2 | | | |
| Example | Photosensitive member | Toner | Charging member | 176.5 | 0.035 | B |
| 32 | 32 | 14 | 2 | | | |
| Example | Photosensitive member | Toner | Charging member | 159.5 | 0.047 | B |
| 33 | 33 | 14 | 2 | | | |
| Example | Photosensitive member | Toner | Charging member | 145.9 | 0.087 | C |
| 34 | 34 | 14 | 2 | | | |
| Example | Photosensitive member | Toner | Charging member | 152.7 | 0.034 | B |
| 35 | 35 | 14 | 2 | | | |
| Example | Photosensitive member | Toner | Charging member | 162.9 | 0.044 | B |
| 36 | 36 | 14 | 2 | | | |
| Example | Photosensitive member | Toner | Charging member | 145.9 | 0.040 | B |
| 37 | 29 | 1 | 2 | | | |
| Example | Photosensitive member | Toner | Charging member | 145.9 | 0.046 | B |
| 38 | 29 | 2 | 2 | | | |
| Example | Photosensitive member | Toner | Charging member | 145.9 | 0.036 | B |
| 39 | 29 | 3 | 2 | | | |
| Example | Photosensitive member | Toner | Charging member | 145.9 | 0.034 | B |
| 40 | 29 | 4 | 2 | | | |
| Example | Photosensitive member | Toner | Charging member | 145.9 | 0.036 | B |
| 41 | 29 | 5 | 2 | | | |
| Example | Photosensitive member | Toner | Charging member | 145.9 | 0.039 | B |
| 42 | 29 | 6 | 2 | | | |
| Example | Photosensitive member | Toner | Charging member | 145.9 | 0.034 | B |
| 43 | 29 | 7 | 2 | | | |
| Example | Photosensitive member | Toner | Charging member | 145.9 | 0.039 | B |
| 44 | 29 | 8 | 2 | | | |
| Example | Photosensitive member | Toner | Charging member | 87.7 | 0.037 | B |
| 45 | 29 | 9 | 2 | | | |
| Example | Photosensitive member | Toner | Charging member | 436.9 | 0.033 | B |
| 46 | 29 | 10 | 2 | | | |
| Example | Photosensitive member | Toner | Charging member | 873.3 | 0.037 | B |
| 47 | 29 | 11 | 2 | | | |
| Example | Photosensitive member | Toner | Charging member | 87.7 | 0.045 | B |
| 48 | 29 | 12 | 2 | | | |
| Example | Photosensitive member | Toner | Charging member | 145.9 | 0.045 | B |
| 49 | 29 | 13 | 2 | | | |
| Example | Photosensitive member | Toner | Charging member | 145.9 | 0.036 | B |
| 50 | 29 | 15 | 2 | | | |
| Example | Photosensitive member | Toner | Charging member | 145.9 | 0.039 | B |
| 51 | 29 | 16 | 2 | | | |
| Example | Photosensitive member | Toner | Charging member | 145.9 | 0.038 | B |
| 52 | 29 | 17 | 2 | | | |
| Example | Photosensitive member | Toner | Charging member | 145.9 | 0.039 | B |
| 53 | 29 | 18 | 2 | | | |
| Example | Photosensitive member | Toner | Charging member | 145.9 | 0.044 | B |
| 54 | 29 | 19 | 2 | | | |
| Example | Photosensitive member | Toner | Charging member | 145.9 | 0.037 | B |
| 55 | 29 | 20 | 2 | | | |
| Example | Photosensitive member | Toner | Charging member | 145.9 | 0.044 | B |
| 56 | 29 | 21 | 2 | | | |
| Example | Photosensitive member | Toner | Charging member | 145.9 | 0.039 | B |
| 57 | 29 | 22 | 2 | | | |
| Example | Photosensitive member | Toner | Charging member | 145.9 | 0.042 | B |
| 58 | 29 | 23 | 2 | | | |
| Example | Photosensitive member | Toner | Charging member | 145.9 | 0.041 | B |
| 59 | 29 | 14 | 1 | | | |
| Example | Photosensitive member | Toner | Charging member | 95.9 | 0.036 | B |
| 60 | 33 | 9 | 2 | | | |
| Example | Photosensitive member | Toner | Charging member | 359.2 | 0.039 | B |
| 61 | 30 | 24 | 2 | | | |
| Example | Photosensitive member | Toner | Charging member | 108.1 | 0.023 | A |
| 62 | 30 | 9 | 2 | | | |
| Example | Photosensitive member | Toner | Charging member | 239.0 | 0.015 | A |
| 63 | 33 | 25 | 2 | | | |
| Example | Photosensitive member | Toner | Charging member | 176.5 | 0.013 | A |
| 64 | 3 | 1 | 2 | | | |
| Example | Photosensitive member | Toner | Charging member | 159.5 | 0.013 | A |
| 65 | 33 | 1 | 2 | | | |
| Example | Photosensitive member | Toner | Charging member | 159.5 | 0.019 | A |
| 66 | 33 | 13 | 2 | | | |
| Example | Photosensitive member | Toner | Charging member | 159.5 | 0.019 | A |
| 67 | 33 | 23 | 2 | | | |
| Example | Photosensitive member | Toner | Charging member | 176.5 | 0.019 | A |
| 68 | 3 | 14 | 1 | | | |
| Example | Photosensitive member | Toner | Charging member | 159.5 | 0.017 | A |
| 69 | 33 | 14 | 1 | | | |
| Example | Photosensitive member | Toner | Charging member | 145.9 | 0.015 | A |
| 70 | 29 | 1 | 1 | | | |
| Example | Photosensitive member | Toner | Charging member | 145.9 | 0.019 | A |
| 71 | 34 | 1 | 1 | | | |
| Example | Photosensitive member | Toner | Charging member | 145.9 | 0.022 | A |
| 72 | 34 | 13 | 1 | | | |
| Example | Photosensitive member | Toner | Charging member | 145.9 | 0.027 | A |
| 73 | 34 | 23 | 1 | | | |
| Example | Photosensitive member | Toner | Charging member | 176.5 | 0.008 | A |
| 74 | 3 | 1 | 1 | | | |
| Example | Photosensitive member | Toner | Charging member | 159.5 | 0.006 | A |
| 75 | 33 | 1 | 1 | | | |

TABLE 10

| | | | | | Evaluations of transfer | |
|---|---|---|---|---|---|---|
| | | | | | properties | |
| | | | | | After 10,000 sheets were | |
| | | | | | printed | |
| | | | | | Transfer residue | |
| Example | Photosensitive member | Toner | Charging member | η/q | concentration | Rank |
| Comparative | Comparative | Toner 1 | Charging member | 159.5 | 0.115 | D |
| Example 1 | photosensitive member 1 | | 1 | | | |
| Comparative | Comparative | Toner 1 | Charging member | 162.9 | 0.123 | D |
| Example 2 | photosensitive member 2 | | 1 | | | |
| Comparative | Comparative | Toner 1 | Charging member | 156.1 | 0.128 | D |
| Example 3 | photosensitive member 3 | | 1 | | | |
| Comparative | Comparative | Toner 1 | Charging member | 149.3 | 0.114 | D |
| Example 4 | photosensitive member 4 | | 1 | | | |
| Comparative | Comparative | Toner 1 | Charging member | 166.3 | 0.118 | D |
| Example 5 | photosensitive member 5 | | 1 | | | |
| Comparative | Comparative | Toner 1 | Charging member | 166.3 | 0.113 | D |
| Example 6 | photosensitive member 6 | | 1 | | | |
| Comparative | Comparative | Toner 1 | Charging member | 162.9 | 0.122 | D |
| Example 7 | photosensitive member 7 | | 1 | | | |
| Comparative | Comparative | Toner 1 | Charging member | 156.1 | 0.112 | D |
| Example 8 | photosensitive member 8 | | 1 | | | |
| Comparative | Comparative | Toner 1 | Charging member | 186.6 | 0.127 | D |
| Example 9 | photosensitive member 9 | | 1 | | | |
| Comparative | Comparative | Toner 1 | Charging member | 186.6 | 0.117 | D |
| Example 10 | photosensitive member 10 | | 1 | | | |
| Comparative | Comparative | Toner 1 | Charging member | 190.0 | 0.123 | D |
| Example 11 | photosensitive member 11 | | 1 | | | |
| Comparative | Comparative | Toner 1 | Charging member | 183.2 | 0.118 | D |
| Example 12 | photosensitive member 12 | | 1 | | | |
| Comparative | Comparative | Toner 1 | Charging member | 159.5 | 0.129 | D |
| Example 13 | photosensitive member 13 | | 1 | | | |
| Comparative | Comparative | Toner 1 | Charging member | 159.5 | 0.112 | D |
| Example 14 | photosensitive member 14 | | 1 | | | |
| Comparative | Comparative | Toner 1 | Charging member | 179.8 | 0.127 | D |
| Example 15 | photosensitive member 15 | | 1 | | | |
| Comparative | Comparative | Toner 1 | Charging member | 179.8 | 0.127 | D |
| Example 16 | photosensitive member 16 | | 1 | | | |
| Comparative | Comparative | Toner 13 | Charging member | 159.5 | 0.110 | D |
| Example 17 | photosensitive member 1 | | 1 | | | |
| Comparative | Comparative | Toner 23 | Charging member | 159.5 | 0.115 | D |
| Example 18 | photosensitive member 1 | | 1 | | | |
| Comparative | Photosensitive member 3 | Comparative | Charging member | 176.5 | 0.107 | D |
| Example 19 | | toner 1 | 1 | | | |
| Comparative | Photosensitive member 3 | Comparative | Charging member | — | 0.105 | D |
| Example 20 | | toner 2 | 1 | | | |
| Comparative | Photosensitive member 3 | Comparative | Charging member | — | 0.122 | D |
| Example 21 | | toner 3 | 1 | | | |
| Comparative | Photosensitive member 33 | Comparative | Charging member | 159.5 | 0.116 | D |
| Example 22 | | toner 1 | 1 | | | |
| Comparative | Comparative | Comparative | Charging member | 159.5 | 0.145 | D |
| Example 23 | photosensitive member 1 | toner 1 | 1 | | | |

The present disclosure can provide a process cartridge having improved transfer properties during repeated use under an environment at a high temperature and a high humidity.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-039619, filed Mar. 14, 2022, which is hereby incorporated by reference herein in its entirety.

What is claimed is:

1. A process cartridge detachably attachable to a main body of an electrophotographic apparatus, the process cartridge comprising:
an electrophotographic photosensitive member,
a toner, and
a developing member that feeds the toner to the electrophotographic photosensitive member,
wherein the electrophotographic photosensitive member comprises a surface layer containing a (meth)acrylic resin having a urethane structure,
the toner comprises:
a toner particle, and
a hydrotalcite particle as an external additive, and
the hydrotalcite particle contains fluorine in filter fitting analysis in STEM-EDS analysis.

2. The process cartridge according to claim 1, wherein the surface layer in the electrophotographic photosensitive member has an elastic deformation rate of 45% or more.

3. The process cartridge according to claim 1, wherein the hydrotalcite particle contains magnesium and aluminum in the filter fitting analysis in the STEM-EDS analysis.

4. The process cartridge according to claim 1, wherein fluorine is present inside the hydrotalcite particle in the line analysis in the STEM-EDS analysis.

5. The process cartridge according to claim 1, wherein, when the elastic deformation rate of the surface layer in the electrophotographic photosensitive member is defined as η [%] and a proportion of the hydrotalcite particle to the toner in the toner is defined as q [% by mass], q and q satisfy the relation represented by Expression (A):
100≤η/q≤300 Expression (A).

6. The process cartridge according to claim 1, wherein
the process cartridge comprises a charging member,
the charging member comprises an electroconductive support, and an electroconductive layer disposed on an outer circumferential surface of the electroconductive support, and
the charging member has a ten-point average surface roughness Rz of the outer circumferential surface of 5 to 20 μm.

7. An electrophotographic apparatus comprising a process cartridge detachably attachable to a body of the electrophotographic apparatus,
wherein the process cartridge comprises:
an electrophotographic photosensitive member,
a toner, and
a developing member that feeds the toner to the electrophotographic photosensitive member,
the electrophotographic photosensitive member comprises a surface layer containing a (meth)acrylic resin having a urethane structure,
the toner comprises:
a toner particle, and
a hydrotalcite particle as an external additive, and
the hydrotalcite particle contains fluorine in filter fitting analysis in STEM-EDS analysis.
